(19) United States
(12) Patent Application Publication
(10) Pub. No.: US 2016/0366439 A1
(43) Pub. Date: Dec. 15, 2016

(54) PALETTE COPY EXTENSION

(71) Applicant: QUALCOMM Incorporated, San Diego, CA (US)

(72) Inventors: Wei Pu, Pittsburgh, PA (US); Marta Karczewicz, San Diego, CA (US); Feng Zou, San Diego, CA (US); Rajan Laxman Joshi, San Diego, CA (US); Vadim Seregin, San Diego, CA (US)

(21) Appl. No.: 15/179,758

(22) Filed: Jun. 10, 2016

Related U.S. Application Data
(60) Provisional application No. 62/174,981, filed on Jun. 12, 2015.

(51) Int. Cl. H04N 19/593; H04N 19/159; H04N 19/503; H04N 19/182; H04N 19/176

(52) U.S. Cl. CPC H04N 19/593; H04N 19/182; H04N 19/176; H04N 19/503; H04N 19/159

(57) ABSTRACT

Techniques are described for using pixel values of pixels in a neighboring block as part of palette mode coding. A video decoder may copy pixel values of a pixel in a last row or column of a neighboring block as predictor or reconstructed pixel values for a run of pixels as part of extended index copy run for palette mode coding. The pixel in the last row or column of the neighboring block is the same line as the run of pixels.

This application claims the benefit of U.S. Provisional Application No. 62/174,981 filed Jun. 12, 2015, the entire content of which is incorporated herein by reference.

### TECHNICAL FIELD

This disclosure relates to video encoding and decoding.

### BACKGROUND

Digital video capabilities can be incorporated into a wide range of devices, including digital televisions, digital direct broadcast systems, wireless broadcast systems, personal digital assistants (PDAs), laptop or desktop computers, tablet computers, e-book readers, digital cameras, digital recording devices, digital media players, video gaming devices, video game consoles, cellular or satellite radio telephones, so-called “smart phones,” video teleconferencing devices, video streaming devices, and the like. Digital video devices implement video compression techniques, such as those described in the standards defined by MPEG-2, MPEG-4, ITU-T H.263, ITU-T H.264/MPEG-4, Part 10, Advanced Video Coding (AVC), the High Efficiency Video Coding (HEVC) standard presently under development, and extensions of such standards. The video devices may transmit, receive, encode, decode, and/or store digital video information more efficiently by implementing such video compression techniques.

Video compression techniques perform spatial (intra-picture) prediction and/or temporal (inter-picture) prediction to reduce or remove redundancy inherent in video sequences. For block-based video coding, a video slice (i.e., a video frame or a portion of a video frame) may be partitioned into video blocks. Video blocks in an intra-coded (I) slice of a picture are encoded using spatial prediction with respect to reference samples in neighboring blocks in the same picture. Video blocks in an inter-coded (P or B) slice of a picture may use spatial prediction with respect to reference samples in neighboring blocks in the same picture or temporal prediction with respect to reference samples in other reference pictures. Pictures may be referred to as frames, and reference pictures may be referred to as reference frames.

Spatial or temporal prediction results in a predictive block for a block to be coded. Residual data represents pixel differences between the original block to be coded and the predictive block. An inter-coded block is encoded according to a motion vector that points to a block of reference samples forming the predictive block, and the residual data indicates the difference between the coded block and the predictive block. An intra-coded block is encoded according to an intra-coding mode and the residual data. For further compression, the residual data may be transformed from the pixel domain to a transform domain, resulting in residual coefficients, which then may be quantized. The quantized coefficients, initially arranged in a two-dimensional array, may be scanned in order to produce a one-dimensional vector of coefficients, and entropy coding may be applied to achieve even more compression.

### SUMMARY

Techniques of this disclosure relate to palette-based video coding. For example, in palette-based coding, a video coder (a video encoder or video decoder) may form a “palette” as a table of colors (or tables of color (or tables of color component values) for representing the video data of the particular area (e.g., a given block). Palette-based coding may be especially useful for coding areas of video data having a relatively small number of colors. Rather than coding actual pixel values (or their residuals), the video coder may code index values for one or more of the pixels that relate the pixels with entries in the palette representing the colors of the pixels. For instance, the techniques of this disclosure may be related to new processes of predicting or coding a block in palette mode to improve coding efficiency and/or reduce codec complexity.

In the example techniques described in this disclosure, the video coder uses extended index copy for palette mode coding a current block. In extended index copy for palette mode coding of a current block, pixels of a last column or last row of a neighboring block to the current block can be utilized to set an index copy run. In the index copy run, the video coder copies one or more pixel values of pixels in the last row or column of the neighboring block as predictor pixel values or final reconstructed pixel values for pixels in the same line as the pixels in the neighboring block.

In one example, the disclosure describes a method of decoding video data, the method comprising receiving information indicating that extended index copy run is enabled for a run of pixels in a line in a current block in palette mode coding of the current block, wherein in the extended index copy run, a pixel value of a pixel in a neighboring block is copied for pixels in the run of pixels in the current block, and wherein the pixel in the neighboring block is in same line as the run of pixels in the current block and inline with the run of pixels relative to a scan order of the current block, copying the pixel value of the pixel from the neighboring block as predictor pixel values or final reconstructed pixel values for pixels in the run of pixels in the current block based on extended index copy run being enabled for the run of pixels in the line in the current block in palette mode coding of the current block, and reconstructing the current block at least in part based on the predictor pixel values or the final reconstructed pixel values for pixels in the run of pixels in the line in the current block.

In one example, the disclosure describes a device for decoding video data, the device comprising a video data memory configured to store pixel values of pixels, and a video decoder coupled to the video data memory and comprising at least one of fixed-function or programmable circuitry. The video decoder is configured to receive information indicating that extended index copy run is enabled for a run of pixels in a line in a current block in palette mode coding of the current block, wherein in the extended index copy run, a pixel value of a pixel in a neighboring block stored in the video data memory is copied for pixels in the run of pixels in the current block, and wherein the pixel in the neighboring block is in same line as the run of pixels in the current block and inline with the run of pixels relative to a scan order of the current block, copy from the video data memory the pixel value of the pixel from the neighboring block as predictor pixel values or final reconstructed pixel values for pixels in the run of pixels in the current block based on extended index copy run being enabled for the run of pixels in the line in the current block in palette mode coding of the current block, and reconstruct the current block at least in part based on the predictor pixel values or the final reconstructed pixel values for pixels in the run of pixels in the line in the current block.

In one example, the disclosure describes a computer-readable storage medium storing instructions that, when executed, cause one or more processors of a device for video decoding to receive information indicating that extended index copy run is enabled for a run of pixels in a line in a current block in palette mode coding of the current block, wherein in the extended index copy run, a pixel value of a pixel in a neighboring block is copied for pixels in the run of pixels in the current block, and wherein the pixel in the neighboring block is in same line as the run of pixels in the current block and inline with the run of pixels relative to a scan order of the current block, copy the pixel value of the pixel from the neighboring block as predictor pixel values or final reconstructed pixel values for pixels in the run of pixels in the current block based on extended index copy run being enabled for the run of pixels in the line in the current block in palette mode coding of the current block, and reconstruct the current block at least in part based on the predictor pixel values or the final reconstructed pixel values for pixels in the run of pixels in the line in the current block.

The details of one or more examples of the disclosure are set forth in the accompanying drawings and the description below. Other features, objects, and advantages will be apparent from the description, drawings, and claims.

### BRIEF DESCRIPTION OF DRAWINGS

FIG. 1 is a block diagram illustrating an example video coding system that may utilize the techniques described in this disclosure.

FIG. 2 is a block diagram illustrating an example video encoder that may implement the techniques described in this disclosure.

FIG. 3 is a block diagram illustrating an example video decoder that may implement the techniques described in this disclosure.

FIG. 4 is a conceptual diagram illustrating an example of determining palette entries for palette-based video coding, consistent with techniques of this disclosure.

FIG. 5A is a conceptual diagram illustrating an example of an extended index copy, consistent with techniques of this disclosure.

FIG. 5B is a conceptual diagram illustrating an example of an extended copy above, consistent with techniques of this disclosure.

FIG. 6 is a conceptual diagram illustrating an example of an extended index copies with individual line flag, consistent with techniques of this disclosure.

FIG. 7 is a flowchart illustrating an example method of decoding video data, consistent with techniques of this disclosure.

FIG. 8 is a flowchart illustrating an example method of encoding video data, consistent with techniques of this disclosure.

### DETAILED DESCRIPTION

Aspects of this disclosure are directed to techniques for video coding and compression. In particular, this disclosure describes techniques for palette-based coding of video data. In traditional video coding, images are assumed to be continuous-tone and spatially smooth. Based on these assumptions, various tools have been developed such as block-based transform, filtering, etc., and such tools have shown good performance for natural content videos.

However, in applications like remote desktop, collaborative work and wireless display, computer generated screen content may be the dominant content to be compressed. This type of content tends to have discrete-tone and feature sharp lines, and high contrast object boundaries. The assumption of continuous-tone and smoothness may no longer apply, and thus, traditional video coding techniques may be inefficient ways to compress the content.

This disclosure describes palette-based coding, which may be particularly suitable for screen generated content coding (e.g., screen content coding (SCC)), but the techniques are not limited to SCC. The techniques for palette-based coding of video data may be used with one or more other coding techniques, such as techniques for inter- or intra-predictive coding. For example, as described in greater detail below, an encoder or decoder, or combined encoder-decoder (codec), may be configured to perform inter- and intra-predictive coding, as well as palette-based coding.

In some palette mode coding techniques, a video coder determines a palette index for a pixel in a block, and determines that a run of pixels in the block following that pixel (e.g., pixels in the same line) share the same palette index. Such palette mode coding techniques are referred to as regular copy index. In some palette mode coding techniques, a video coder determines that a run of pixels share the same palette indices as above pixels for a horizontal scan of the current block or left pixels for vertical scan (e.g., pixels not in the same line). Such palette mode coding techniques are referred to as regular copy above.

This disclosure describes an extended index copy run technique, where rather than being limited to pixels within the same block for palette mode coding, pixels in a block other than the current block can be used for palette mode coding. For instance, in extended index copy run one or more pixel values of a pixel in a neighboring block that is in the same line as the run of pixels of the current block are used to determine the pixel values of the pixels in the run of pixels of the current block.

As an example, for a horizontal scan order for the current block, a video coder may copy one or more pixel values of a pixel in the last column of a left neighboring block (e.g., the column of the left neighboring block that borders the current block) as predictor or final pixel values for a run of pixels in the current block. The run of pixels in the current block is in the same row as the pixel in the last column of the left neighboring block. For a vertical scan order for the current block, a video coder may copy one or more pixels of a pixel in the last row of an above neighboring block (e.g., the row of the above neighboring block that borders the current block) as predictor or final pixel values for a run of pixels in the current block. The run of pixels in the current block is in the same column as the pixel in the last row of the above neighboring block.

In addition to using pixels from neighboring blocks for palette mode coding, there may be some other differences between extended index copy and regular index copy in palette mode coding. In regular index copy, a video coder copies the palette index of a pixel for pixels in a run of pixels and then determines the predictor pixel values or final pixel values for pixels in the run of pixels based on the copied palette index. However, in extended index copy, a video coder copies the actual pixel values, and not the palette index, of a pixel for pixels in a run of pixels as the predictor pixel values or the final pixel values.

The above describes an example of extended index copy. A video coder may similarly utilize extended copy above. In extended copy above, a video coder copies pixel values from pixels in a last row or column of a neighboring block as predictor pixel values or final pixel values for a run of pixels. However, unlike extended index copy, in extended copy above, the pixels whose pixel values the video coder copies are not in the same line as the run of the pixels.

In some examples, a video coder may determine whether extended index copy or extended copy above is enabled, and determine which one of extended index copy or extended copy above is to be applied to a run of pixels. The video coder may then copy pixel values from a neighboring block based on whether extended index copy or extended copy above is to be applied to the run of pixels.

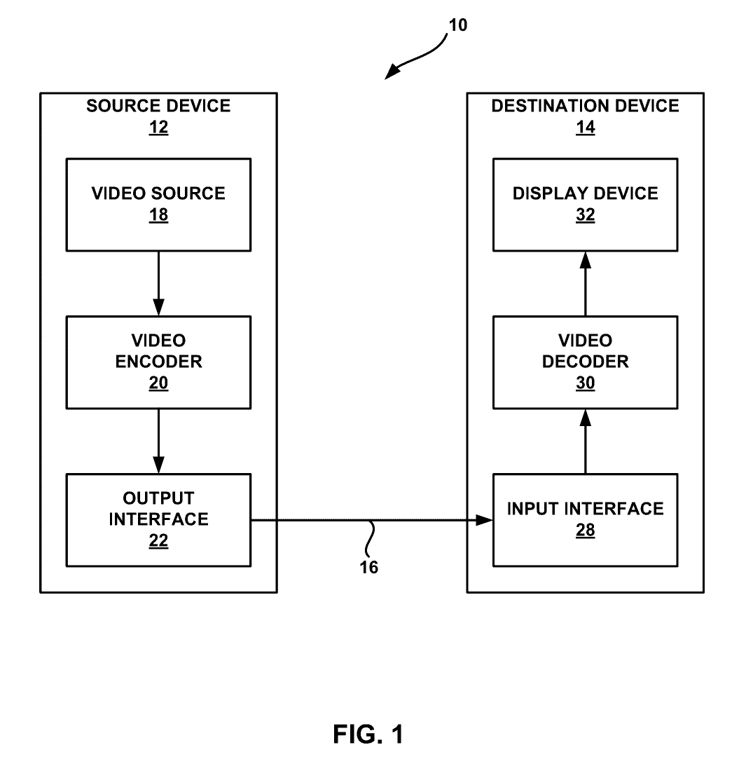

FIG. 1 is a block diagram illustrating an example video coding system 10 that may utilize the techniques of this disclosure. As used herein, the term “video coder” refers generically to both video encoders and video decoders. In this disclosure, the terms “video coding” or “coding” may refer generically to video encoding or video decoding. Video encoder 20 and video decoder 30 of video coding system 10 represent examples of devices that may be configured to perform techniques for palette-based video coding in accordance with various examples described in this disclosure. For example, video encoder 20 and video decoder 30 may be configured to selectively code various blocks of video data, such as CUs or PUs in HEVC coding, using either palette-based coding (i.e., palette mode coding) or non-palette-based coding (i.e., non-palette mode coding). Non-palette-based coding modes may refer to various inter-predictive temporal coding modes or intra-predictive spatial coding modes, such as the various coding modes specified by the high efficiency video coding (HEVC) standard, also referred to as the H.265 video coding standard. The full citation for the HEVC standard is ITU-T H.265, Series H: Audiovisual and Multimedia Systems, Infrastructure of audiovisual services—Coding of moving video, Advanced video coding for generic audiovisual services, The International Telecommunication Union. October 2014.

As shown in FIG. 1, video coding system 10 includes a source device 12 and a destination device 14. Source device 12 generates encoded video data. Accordingly, source device 12 may be referred to as a video encoding device or a video encoding apparatus. Destination device 14 may decode the encoded video data generated by source device 12. Accordingly, destination device 14 may be referred to as a video decoding device or a video decoding apparatus. Source device 12 and destination device 14 may be examples of video coding devices or video coding apparatuses.

Source device 12 and destination device 14 may comprise a wide range of devices, including desktop computers, mobile computing devices, notebook (e.g., laptop) computers, tablet computers, set-top boxes, telephone handsets such as so-called “smart” phones, televisions, cameras, display devices, digital media players, video gaming consoles, in-car computers, wireless communication devices, or the like.

Destination device 14 may receive encoded video data from source device 12 via a channel 16. Channel 16 may comprise one or more media or devices capable of moving the encoded video data from source device 12 to destination device 14. In one example, channel 16 may comprise one or more communication media that enable source device 12 to transmit encoded video data directly to destination device 14 in real-time. In this example, source device 12 may modulate the encoded video data according to a communication standard, such as a wireless communication protocol, and may transmit the modulated video data to destination device 14. The one or more communication media may include wireless and/or wired communication media, such as a radio frequency (RF) spectrum or one or more physical transmission lines. The one or more communication media may form part of a packet-based network, such as a local area network, a wide-area network, or a global network (e.g., the Internet). The one or more communication media may include routers, switches, base stations, or other equipment that facilitate communication from source device 12 to destination device 14.

In another example, channel 16 may include a storage medium that stores encoded video data generated by source device 12. In this example, destination device 14 may access the storage medium, e.g., via disk access or card access. The storage medium may include a variety of locally-accessed data storage media such as Blu-ray discs, DVDs, CD-ROMs, flash memory, or other suitable digital storage media for storing encoded video data.

In a further example, channel 16 may include a file server or another intermediate storage device that stores encoded video data generated by source device 12. In this example, destination device 14 may access encoded video data stored at the file server or other intermediate storage device via streaming or download. The file server may be a type of server capable of storing encoded video data and transmitting the encoded video data to destination device 14. Example file servers include web servers (e.g., for a website), file transfer protocol (FTP) servers, network attached storage (NAS) devices, and local disk drives.

Destination device 14 may access the encoded video data through a standard data connection, such as an Internet connection. Example types of data connections may include wireless channels (e.g., Wi-Fi connections), wired connections (e.g., DSL, cable modem, etc.), or combinations of both that are suitable for accessing encoded video data stored on a file server. The transmission of encoded video data from the file server may be a streaming transmission, a download transmission, or a combination of both.

The techniques of this disclosure are not limited to wireless applications or settings. The techniques may be applied to video coding in support of a variety of multimedia applications, such as over-the-air television broadcasts, cable television transmissions, satellite television transmissions, streaming video transmissions, e.g., via the Internet, encoding of video data for storage on a data storage medium, decoding of video data stored on a data storage medium, or other applications. In some examples, video coding system 10 may be configured to support one-way or two-way video transmission to support applications such as video streaming, video playback, video broadcasting, and/or video telephony.

Video coding system 10 illustrated in FIG. 1 is merely an example and the techniques of this disclosure may apply to video coding settings (e.g., video encoding or video decoding) that do not necessarily include any data communication between the encoding and decoding devices. In other examples, data is retrieved from a local memory, streamed over a network, or the like. A video encoding device may encode and store data to memory, and/or a video decoding device may retrieve and decode data from memory. In many examples, the encoding and decoding is performed by devices that do not communicate with one another, but simply encode data to memory and/or retrieve and decode data from memory.

In the example of FIG. 1, source device 12 includes a video source 18, a video encoder 20, and an output interface 22. In some examples, output interface 22 may include a modulator/demodulator (modem) and/or a transmitter. Video source 18 may include a video capture device, e.g., a video camera, a video archive containing previously-captured video data, a video feed interface to receive video data from a video content provider, and/or a computer graphics system for generating video data, or a combination of such sources of video data.

Video encoder 20 may encode video data from video source 18. In some examples, source device 12 directly transmits the encoded video data to destination device 14 via output interface 22. In other examples, the encoded video data may also be stored onto a storage medium or a file server for later access by destination device 14 for decoding and/or playback.

In the example of FIG. 1, destination device 14 includes an input interface 28, a video decoder 30, and a display device 32. In some examples, input interface 28 includes a receiver and/or a modem. Input interface 28 may receive encoded video data over channel 16. Display device 32 may be integrated with or may be external to destination device 14. In general, display device 32 displays decoded video data. Display device 32 may comprise a variety of display devices, such as a liquid crystal display (LCD), a plasma display, an organic light emitting diode (OLED) display, or another type of display device.

Video encoder 20 and video decoder 30 each may be implemented as fixed-function or programmable circuits in any of a variety of suitable circuitry, such as one or more integrated circuits, microprocessors, digital signal processors (DSPs), application-specific integrated circuits (ASICs), field-programmable gate arrays (FPGAs), discrete logic, hardware, or any combinations thereof. If the techniques are implemented partially in software, a device may store instructions for the software in a suitable, non-transitory computer-readable storage medium and may execute the instructions in hardware using one or more processors to perform the techniques of this disclosure. Any of the foregoing (including hardware, software, a combination of hardware and software, etc.) may be considered to be one or more processors. Each of video encoder 20 and video decoder 30 may be included in one or more encoders or decoders, either of which may be integrated as part of a combined encoder/decoder (CODEC) in a respective device.

This disclosure may generally refer to video encoder 20 “signaling” or “transmitting” certain information to another device, such as video decoder 30. The term “signaling” or “transmitting” may generally refer to the communication of syntax elements and/or other data used to decode the compressed video data. Such communication may occur in real- or near-real-time. Alternately, such communication may occur over a span of time, such as might occur when storing syntax elements to a computer-readable storage medium in an encoded bitstream at the time of encoding, which then may be retrieved by a decoding device at any time after being stored to this medium.

In some examples, video encoder 20 and video decoder 30 operate according to a video compression standard, such as HEVC standard mentioned above. In addition to the base HEVC standard, there are ongoing efforts to produce scalable video coding, multiview video coding, and 3D coding extensions for HEVC. In addition, palette-based coding modes (e.g., as described in this disclosure) may be provided for by an extension of the HEVC standard. For example, palette mode coding techniques are described in Rajan Joshi et al., “High Efficiency Video Coding (HEVC) Screen Content Coding: Draft 2,” JCTVC-S1005, Sapporo, JP, 30 Jun.-9 Jul. 2014 (hereinafter “SCC Draft 2”). A copy of SCC Draft 2 is available at http://phenix.int-evey.fr/jct/doc_end_user/documents/19_Strasbourg/wg11/JCTVC-S1005-v1.zip. In some examples, the techniques described in this disclosure for palette mode coding may be applied to encoders and decoders configured to operate according to other video coding standards, such as the ITU-T-H.264/AVC standard or future standards. Accordingly, application of a palette-based coding mode for coding of coding units (CUs) or prediction units (PUs) in an HEVC codec is described for purposes of example.

In JCTVC-S1005, a pixel in palette mode may use its above neighbor (copy above run) or previous neighbor in scanning order (index copy run) to predict its value. When such information is not available (e.g., in the first line of the block), the corresponding run type may be disabled.

Palette-based coding techniques are also described in Rajan Joshi et al., “High Efficiency Video Coding (HEVC) Screen Content Coding Draft Text 6,” JCTVC-W1005, San Diego, US, May 29, 2016 (hereinafter “SCC Draft 6”). A copy of Draft 6 is available at http://phenix.it-sudparis.eu/jct/doc_end_user/current_document.php?id=10481.

In JCTVC-U0061, “CE1: Test A.1: Extended copy above mode to the first line with index adjustment bits,” available from http://phenix.int-evey.fr/jct/doc_end_user/current_document.php?id=10065, for horizontal scanning, pixels in the line above the first line in the block, named as line #-1 hereafter, or for vertical scanning, in the column to the left of the first column, named as column #-1 hereafter, may be used in copy above run mode. In JCTVC-U0066, “CE1-related: Row-based copy pixel from neighbouring CU,” available from http://phenix.int-evry.fr/jct/doc_end_user/current_document.php?id=10070, a simplification was proposed which only allow the extended copy above mode to be used starting for the first pixel in the block, and the extended copy above run, if used, may need to span N whole lines, where N>0.

When extended copy above run is enabled, if the scan order of a current block is a horizontal scan, then video encoder 20 or video decoder 30 may utilize the pixel values of pixels in a last row of a block above the current block for determining the pixel values in columns of runs of pixels in the current block. For example, video encoder 20 or video decoder 30 may determine that the pixel values of one or more pixels (e.g., run of pixels) in a first column of the current block is the same as a first pixel in the last row of the above block. Video encoder 20 or video decoder 30 may determine that the pixel values of one or more pixels (e.g., run of pixels) in a second column of the current block is the same as a second pixel in the last row of the above block, and so forth.

In this example, the pixel value of a pixel in a last row of the above block is the same as pixel values of a run of pixels in the current block that are in the same line. For example, the first pixel in the last row of the above block is in the same line (e.g., same column) as a run of pixels in the first column of the current block. In this example, the pixel in the above block is orthogonal to the run of pixels in the current block relative to a scan order of the current block (e.g., scan order is horizontal and the pixel in the above block is vertically above the run of pixels in the current block).

In extended copy above run, if the scan order of a current block is a vertical scan, then video encoder 20 or video decoder 30 may utilize the pixel values of pixels in a last column of a block to the left of the current block for determining the pixel values in rows of runs of pixels in the current block. For example, video encoder 20 or video decoder 30 may determine that the pixel values of one or more pixels (e.g., run of pixels) in a first row of the current block is the same as a first pixel in the last column of the left block. Video encoder 20 or video decoder 30 may determine that the pixel values of one or more pixels (e.g., run of pixels) in a second row of the current block is the same as a second pixel in the last column of the left block, and so forth.

In this example, the pixel value of a pixel in a last column of the left block is the same as pixel values of a run of pixels in the current block that are in the same line. For example, the first pixel in the last column of the left block is in the same line (e.g., same row) as a run of pixels in the first row of the current block. In this example, the pixel in the left block is orthogonal to the run of pixels in the current block relative to a scan order of the current block (e.g., scan order is vertical and the pixel in the left block is horizontally to the left of the run of pixels in the current block).

In the extended above copy run, video encoder 20 and video decoder 30 may utilize the actual pixel values of the pixels in the above or left block rather than the palette indices. In regular copy above (e.g., non-extended above copy run), a palette index of a pixel in the current block is copied as the palette index for a run of pixels. In extended above copy run, video decoder 30 copies the pixel values, and not necessarily the palette index.

This disclosure describes an improvement on top of JCTVC-U0066 to improve coding efficiency. For example, this disclosure describes example techniques for an extended index copy run. The extended index copy run may be similar to the extended copy above run described above. However, rather than using pixel values of a pixel in a neighboring block (e.g., above block or left block based on scan order) that is orthogonal to the run of pixels in the current block relative to the scan order, extended index copy run uses pixel values of pixels in a neighboring block that is inline with the run of pixels in the current block relative to the scan order.

Prior to describing extended index copy run in more detail, the following is a description of video coding to assist with understanding. In HEVC and other video coding standards, a video sequence typically includes a series of pictures. Pictures may also be referred to as “frames.” A picture may include three sample arrays, denoted S_{L}, S_{Cb} and S_{Cr}. S_{L} is a two-dimensional array (i.e., a block) of luma samples. S_{Cb} is a two-dimensional array of Cb chrominance samples. S_{Cr} is a two-dimensional array of Cr chrominance samples. Chrominance samples may also be referred to herein as “chroma” samples. In other instances, a picture may be monochrome and may only include an array of luma samples.

To generate an encoded representation of a picture, video encoder 20 may generate a set of coding tree units (CTUs). Each of the CTUs may be a coding tree block of luma samples, two corresponding coding tree blocks of chroma samples, and syntax structures used to code the samples of the coding tree blocks. A coding tree block may be an N×N block of samples. A CTU may also be referred to as a “tree block” or a “largest coding unit” (LCU). The CTUs of HEVC may be broadly analogous to the macroblocks of other standards, such as H.264/AVC. However, a CTU is not necessarily limited to a particular size and may include one or more coding units (CUs). A slice may include an integer number of CTUs ordered consecutively in the raster scan.

To generate a coded CTU, video encoder 20 may recursively perform quad-tree partitioning on the coding tree blocks of a CTU to divide the coding tree blocks into coding blocks, hence the name “coding tree units.” A coding block is an N×N block of samples. A CU may be a coding block of luma samples and two corresponding coding blocks of chroma samples of a picture that has a luma sample array, a Cb sample array and a Cr sample array, and syntax structures used to code the samples of the coding blocks. Video encoder 20 may partition a coding block of a CU into one or more prediction blocks. A prediction block may be a rectangular (i.e., square or non-square) block of samples on which the same prediction is applied. A prediction unit (PU) of a CU may be a prediction block of luma samples, two corresponding prediction blocks of chroma samples of a picture, and syntax structures used to predict the prediction block samples. Video encoder 20 may generate predictive luma, Cb and Cr blocks for luma, Cb and Cr prediction blocks of each PU of the CU.

Video encoder 20 may use intra prediction or inter prediction to generate the predictive blocks for a PU. If video encoder 20 uses intra prediction to generate the predictive blocks of a PU, video encoder 20 may generate the predictive blocks of the PU based on decoded samples of the picture associated with the PU.

If video encoder 20 uses inter prediction to generate the predictive blocks of a PU, video encoder 20 may generate the predictive blocks of the PU based on decoded samples of one or more pictures other than the picture associated with the PU. Video encoder 20 may use uni-prediction or bi-prediction to generate the predictive blocks of a PU. When video encoder 20 uses uni-prediction to generate the predictive blocks for a PU, the PU may have a single motion vector (MV). When video encoder 20 uses bi-prediction to generate the predictive blocks for a PU, the PU may have two MVs.

After video encoder 20 generates predictive luma, Cb and Cr blocks for one or more PUs of a CU, video encoder 20 may generate a luma residual block for the CU. Each sample in the CU's luma residual block indicates a difference between a luma sample in one of the CU's predictive luma blocks and a corresponding sample in the CU's original luma coding block. In addition, video encoder 20 may generate a Cb residual block for the CU. Each sample in the CU's Cb residual block may indicate a difference between a Cb sample in one of the CU's predictive Cb blocks and a corresponding sample in the CU's original Cb coding block. Video encoder 20 may also generate a Cr residual block for the CU. Each sample in the CU's Cr residual block may indicate a difference between a Cr sample in one of the CU's predictive Cr blocks and a corresponding sample in the CU's original Cr coding block.

Furthermore, video encoder 20 may use quad-tree partitioning to decompose the luma, Cb and Cr residual blocks of a CU into one or more luma, Cb and Cr transform blocks. A transform block may be a rectangular block of samples on which the same transform is applied. A transform unit (TU) of a CU may be a transform block of luma samples, two corresponding transform blocks of chroma samples, and syntax structures used to transform the transform block samples. Thus, each TU of a CU may be associated with a luma transform block, a Cb transform block, and a Cr transform block. The luma transform block associated with the TU may be a sub-block of the CU's luma residual block. The Cb transform block may be a sub-block of the CU's Cb residual block. The Cr transform block may be a sub-block of the CU's Cr residual block.

Video encoder 20 may apply one or more transforms to a luma transform block of a TU to generate a luma coefficient block for the TU. A coefficient block may be a two-dimensional array of transform coefficients. A transform coefficient may be a scalar quantity. Video encoder 20 may apply one or more transforms to a Cb transform block of a TU to generate a Cb coefficient block for the TU. Video encoder 20 may apply one or more transforms to a Cr transform block of a TU to generate a Cr coefficient block for the TU.

After generating a coefficient block (e.g., a luma coefficient block, a Cb coefficient block or a Cr coefficient block), video encoder 20 may quantize the coefficient block. Quantization generally refers to a process in which transform coefficients are quantized to possibly reduce the amount of data used to represent the transform coefficients, providing further compression. After video encoder 20 quantizes a coefficient block, video encoder 20 may entropy encoding syntax elements indicating the quantized transform coefficients. For example, video encoder 20 may perform Context-Adaptive Binary Arithmetic Coding (CABAC) on the syntax elements indicating the quantized transform coefficients. Video encoder 20 may output the entropy-encoded syntax elements in a bitstream.

Video encoder 20 may output a bitstream that includes the entropy-encoded syntax elements. The bitstream may include a sequence of bits that forms a representation of coded pictures and associated data. The bitstream may comprise a sequence of network abstraction layer (NAL) units. Each of the NAL units includes a NAL unit header and encapsulates a raw byte sequence payload (RBSP). The NAL unit header may include a syntax element that indicates a NAL unit type code. The NAL unit type code specified by the NAL unit header of a NAL unit indicates the type of the NAL unit. A RBSP may be a syntax structure containing an integer number of bytes that is encapsulated within a NAL unit. In some instances, an RBSP includes zero bits.

Different types of NAL units may encapsulate different types of RBSPs. For example, a first type of NAL unit may encapsulate an RBSP for a picture parameter set (PPS), a second type of NAL unit may encapsulate an RBSP for a coded slice, a third type of NAL unit may encapsulate an RBSP for SEI, and so on. NAL units that encapsulate RBSPs for video coding data (as opposed to RBSPs for parameter sets and SEI messages) may be referred to as video coding layer (VCL) NAL units.

Video decoder 30 may receive a bitstream generated by video encoder 20. In addition, video decoder 30 may parse the bitstream to decode syntax elements from the bitstream. Video decoder 30 may reconstruct the pictures of the video data based at least in part on the syntax elements decoded from the bitstream. The process to reconstruct the video data may be generally reciprocal to the process performed by video encoder 20. For instance, video decoder 30 may use MVs of PUs to determine predictive blocks for the PUs of a current CU. In addition, video decoder 30 may inverse quantize transform coefficient blocks associated with TUs of the current CU. Video decoder 30 may perform inverse transforms on the transform coefficient blocks to reconstruct transform blocks associated with the TUs of the current CU. Video decoder 30 may reconstruct the coding blocks of the current CU by adding the samples of the predictive blocks for PUs of the current CU to corresponding samples of the transform blocks of the TUs of the current CU. By reconstructing the coding blocks for each CU of a picture, video decoder 30 may reconstruct the picture.

In some examples, video encoder 20 and video decoder 30 may be configured to perform palette-based coding (i.e., palette mode coding). For example, in palette mode coding, rather than performing the intra-predictive or inter-predictive coding techniques described above, video encoder 20 and video decoder 30 may code a so-called palette as a table of colors for representing the video data of the particular area (e.g., a given block). Each pixel may be associated with an entry in the palette that represents the color of the pixel. For example, video encoder 20 and video decoder 30 may code an index that relates the pixel value to the appropriate value in the palette.

In the example above, video encoder 20 may encode a block of video data by determining a palette for the block, locating an entry in the palette to represent the value of each pixel, and encoding the palette and index values for the pixels relating the pixel value to the palette. Video decoder 30 may obtain, from an encoded bitstream, a palette for a block, as well as index values for the pixels of the block. Video decoder 30 may relate the index values of the pixels to entries of the palette to reconstruct the pixel values of the block.

In some examples, the palette-based coding techniques may be configured for use with one or more video coding standards. For example, High Efficiency Video Coding (HEVC) is a new video coding standard being developed by the Joint Collaboration Team on Video Coding (JCT-VC) of ITU-T Video Coding Experts Group (VCEG) and ISO/IEC Motion Picture Experts Group (MPEG). A recent HEVC text specification draft is described in Bross et al., “High Efficiency Video Coding (HEVC) Text Specification Draft 10 (for FDIS & Consent),” JCVC-L1003_v13, 12^{th} Meeting of JCT-VC of ITU-T SG16 WP 3 and ISO/IEC JCT 1/SC 29/WG 11, 14-23 Jan. 2013 (“HEVC Draft 10”). The most recent publication of the standard is: ITU-T H.265, Series H: Audiovisual and Multimedia Systems, Infrastructure of audiovisual services-Coding of moving video, Advanced video coding for generic audiovisual services, The International Telecommunication Union. October 2014.

With respect to the HEVC framework, as an example, the palette-based coding techniques may be configured to be used as a coding unit (CU) mode. In other examples, the palette-based coding techniques may be configured to be used as a PU mode in the framework of HEVC. Accordingly, all of the following disclosed processes described in the context of a CU mode may, additionally or alternatively, apply to PU. However, these HEVC-based examples should not be considered a restriction or limitation of the palette-based coding techniques described herein, as such techniques may be applied to work independently or as part of other existing or yet to be developed systems/standards. In these cases, the unit for palette coding can be square blocks, rectangular blocks or even regions of non-rectangular shape.

In palette-based coding, a particular area of video data may be assumed to have a relatively small number of colors. A video coder (video encoder 20 or video decoder 30) may code (encode or decode) a so-called “palette” as a table of colors for representing the video data of the particular area (e.g., a given block). Each pixel may be associated with an entry in the palette that represents the color of the pixel. For example, the video coder may code an index that relates the pixel value to the appropriate value in the palette.

In the example above, video encoder 20 may encode a block of video data by determining a palette for the block, locating an entry in the palette to represent the value of each pixel, and encoding the palette with index values for the pixels relating the pixel value to the palette. Video decoder 30 may obtain, from an encoded bitstream, a palette for a block, as well as index values for the pixels of the block. Video decoder 30 may relate the index values of the pixels to entries of the palette to reconstruct the pixel values of the block. Pixels (and/or related index values that indicate a pixel value) may generally be referred to as samples.

It is assumed that samples in the block are processed (e.g., scanned) using horizontal raster scanning order. For example, video encoder 20 may convert a two-dimensional block of indices into a one-dimensional array by scanning the indices using a horizontal raster scanning order. Likewise, video decoder 30 may reconstruct a block of indices using the horizontal raster scanning order. Accordingly, this disclosure may refer to a previous sample as a sample that precedes the sample currently being coded in the block in the scanning order. It should be appreciated that scans other than a horizontal raster san, such as vertical raster scanning order, may also be applicable. The example above is intended provide a general description of palette-based coding.

A palette typically includes entries numbered by an index and representing color component (for example, RGB, YUV, or the like) values or intensities. Both video encoder 20 and video decoder 30 determine the number of palette entries, color component values for each palette entry and the exact ordering of the palette entries for the current block. In this disclosure, it is assumed that each palette entry specifies the values for all color components of a sample. However, the concepts of this disclosure are applicable to using a separate palette for each color component.

In some examples, a palette may be composed using information from previously coded blocks. That is, a palette may contain predicted palette entries predicted from the palette(s) used to code the previous block(s). For example, as described in standard submission document Wei Pu et al., “AHG10: Suggested Software for Palette Coding based on RExt6.0,” JCTVC-Q0094, Valencia, ES, 27 Mar.-4 Apr. 2014 (hereinafter JCTVC-Q0094), a palette may include entries that are copied from a predictor palette. A predictor palette may include palette entries from blocks previously coded using palette mode or other reconstructed samples. For each entry in the predictor palette, a binary flag may be coded to indicate whether the entry associated with the flag is copied to the current palette (e.g., indicated by flag=1). The string of binary flags may be referred to as the binary palette prediction vector. The palette for coding a current block may also include a number of new palette entries, which may be explicitly coded (e.g., separately from the palette prediction vector). An indication of the number of new entries may also be coded. A sum of the predicted entries and new entries may indicate the total palette size in for block.

As proposed JCTVC-Q0094, each sample in a block coded with a palette-based coding mode may be coded using one of the three palette modes, as set forth below:
Escape mode: in this mode, the sample value is not included into a palette as a palette entry and the quantized sample value is signaled explicitly for all color components. It is similar to the signaling of the new palette entries, although for new palette entries, the color component values are not quantized.
CopyFromTop mode (also referred to as CopyAbove mode): in this mode, the palette entry index for the current sample is copied from the sample located directly above in a block.
Value mode (also referred to as Index mode): in this mode, the value of the palette entry index is explicitly signaled.

As described herein, a palette entry index may be referred as a palette index or simply index. These terms can be used interchangeably to describe techniques of this disclosure. In addition, as described in greater detail below, a palette index may have one or more associated color or intensity values. For example, a palette index may have a single associated color or intensity value associated with a single color or intensity component of a pixel (e.g., a Red component of RGB data, a Y component of YUV data, or the like). In another example, a palette index may have multiple associated color or intensity values. In some instances, palette-based coding may be applied to code monochrome video. Accordingly, “color value” may generally refer to any color or non-color component used to generate a pixel value.

For CopyFromTop and Value modes, a syntax element whose value indicates a palette run length (which may also be referred to simply as run or run value) may also be signaled. A run value may indicate a number of consecutive samples (e.g., a run of samples) in a particular scan order in a palette-coded block that are coded together. In some instances, the run of samples may also be referred to as a run of indices, because each sample of the run has an associated index to a palette.

A run value may indicate a run of indices that are coded using the same palette-coding mode. For example, with respect to Value mode, a video coder (video encoder 20 or video decoder 30) may code an index value and a run value that indicates a number of consecutive samples in a scan order that have the same index value and that are being coded with the index value. With respect to CopyFromTop mode, the video coder may code an indication that an index for the current sample value is copied based on an index of an above-neighboring sample (e.g., a sample that is positioned above the sample currently being coded in a block) and a run value that indicates a number of consecutive samples in a scan order that also copy an index value from an above-neighboring sample and that are being coded with the index value.

Hence, the run may specify, for a given mode, the number of subsequent samples that belong to the same mode. In some instances, signaling an index and a run value may be similar to run length coding. In an example for purposes of illustration, a string of consecutive indices of a block may be 0, 2, 2, 2, 2, 5 (e.g., where each index corresponds to a sample in the block). In this example, a video coder may code the second sample (e.g., the first index value of two) using Value mode. After coding an index that is equal to 2, the video coder may code a run of three, which indicates that the three subsequent samples also have the same index value of two. In a similar manner, coding a run of four indices after coding an index using CopyFromTop mode may indicate that a total of five indices are copied from the corresponding indices in the row above the sample position currently being coded.

As noted above, video encoder 20 and video decoder 30 may use a number of different palette coding modes to code indices of a palette. For example, video encoder 20 and video decoder 30 may use an Escape mode, a CopyFromTop mode (also referred to as CopyAbove mode), or a Value mode (also referred to as Index mode) to code indices of a block. In general, coding a sample using “Escape mode” may generally refer coding a sample of a block that does not have a corresponding color represented in a palette for coding the block. As noted above, such samples may be referred to as escape samples or escape pixels.

Another example palette coding mode is described in a third screen content coding core experiment, subtest B.6, as described in Yu-Wen Huang et al., “Description of Screen Content Core Experiment 3 (SCCE3): Palette Mode,” JCTVC-Q1123, Valencia, ES, 27 Mar.-4 Apr. 2014 (hereinafter Q1123), another mode was introduced into the software released by Canon on 26^{th} May 2014. The macro for this mode was “CANON NEW RUN LAST TRANSITION” and may be referred to herein as Transition Run mode. The Transition Run may be similar to Value mode in that video encoder 20 or video decoder 30 may code an index value followed by a run specifying the number of subsequent samples that have the same palette index.

The difference between Value mode and the Transition Run mode is that the index value of the transition run mode is not signaled in the bitstream. Rather, video encoder 20 and video decoder 30 may infer the index value. As described herein, inferring a value may refer to the determination of a value without reference to dedicated syntax that represents the value that is coded in a bitstream. That is, video encoder 20 and video decoder 30 may infer (i.e., determine) a value without coding a dedicated syntax element for the value in a bitstream. The inferred index may be referred to as a transition index.

The following describes example techniques of this disclosure. The techniques may be applied separately or in any combination. For ease of description, the examples are described with respect to a video coder, examples of which include video encoder 20 and video decoder 30. Also, for conciseness, in the following description, unless explicitly specified, it is assumed that horizontal scan is used. The same method may be used to vertical scan as well. For instance, for copy above, in vertical scan may be copy left. The term copy above is used generically for both horizontal and vertical scan.

In some examples, the video coder may use both row #-1 and column #-1 as reference pixels to code the current pixel. Row #-1 refers to the last row in a neighboring block that is above the current block being coded, where the last row is the row of the neighboring block that borders the current block. Column #-1 refers to the last column in a neighboring block that is left of the current block being coded, where the last column is the column of the neighboring block that borders the current block.

This disclosure describes example techniques for implementing extended copy above run and extended index copy run techniques for palette-based video coding. In extended index copy run, if the scan order for the current block is horizontal scan, then video decoder 30 may copy pixel value of a pixel in the last column of the left block (column #-1) as a predictor pixel value or the final reconstructed pixel value for a run of pixels in the current block that are horizontally positioned in the same line as the pixel in the last column. In these examples, the run of pixels refers to a plurality of pixels in consecutive columns of the current block. If the scan order for the current block is vertical scan, then video decoder 30 may copy pixel value of a pixel in the last row of the above block (row #-1) as the a predictor pixel value or the final reconstructed for a run of pixels in the current block that are vertically positioned in the same line as the pixel in the last row. In these examples, the run of pixels refers to a plurality of pixel in consecutive rows of the current block.

In extended copy above run, if the scan order for the current block is horizontal scan, then video decoder 30 may copy pixel value of a pixel in the last row of the above block (row #-1) as a predictor pixel value or the final reconstructed for a run of pixels in the current block that are vertically positioned in the same line as the pixel in the last row. In these examples, the run of pixels refers to a plurality of pixels in consecutive rows of the current block. If the scan order for the current block is vertical scan, then video decoder 30 may copy pixel value of a pixel in the last column of the left block (column #-1) as a predictor pixel value or the final reconstructed for a run of pixels in the current block that are horizontally positioned in the same line as the pixel in the last column. In these examples, the run of pixels refers to a plurality of pixel in consecutive column of the current block.

Video encoder 20 may indicate to video decoder 30 whether extended copy above run or extended index copy run is enabled, and then indicate which one of extended copy above run or extended index copy run is enabled. For example, to indicate whether a current run uses extended copies, video encoder 20 may signal, for the first pixel in the block, a palette_run_type_extension flag into the bitstream, specifying whether the current run uses extended copies. If this flag equals to 0, then video decoder 30 may determine that regular index copy is used (e.g., where the palette index is copied for a run of pixels of a block from a pixel in the same block). Otherwise, video encoder 20 may signal another flag to differentiate whether extended copy above run or extended index copy run is enabled.

There may be other ways in which video encoder 20 may signal information from which video decoder 30 determines whether regular index copy, extended copy above, or extended index copy is enable for a run of pixels. For example, as an alternative signaling, three code words {‘0’, ‘10’, ‘11’ } or {‘1’, ‘01’, ‘00’ } may be assigned to {regular index copy, extended copy above, extended index copy} with any feasible one to one mapping. Based on the code word that video encoder 20 signals, video decoder 30 may determine whether regular index copy, extended copy above, or extended index copy is enabled for a run of pixels (e.g., consecutive rows or columns).

In this sense, a video coder (e.g., video encoder 20 and/or video decoder 30) may be configured to code information indicating whether at least one of extended copy above run or extended index copy run is enabled for a current run of pixels in a current block in palette mode coding of a current block (e.g., via the palette_run_type extension flag and another flag if the palette_run_type extension flag is true or via code words). The video coder may be configured to copy pixels from a neighboring block (e.g., the block having line #-1 or column #-1) as predictor or final reconstructed pixel values of a current line in the current block in response to at least one of the extended copy above run or the extended index copy run being enabled for the current run of pixels in the current block in palette mode video coding of the current block.

Video decoder 30 may receive information indicating that extended index copy run is enabled for a run of pixels in a line in a current block in palette mode coding of the current block. In the extended index copy run, a pixel value of a pixel in a neighboring block is copied for pixels in the run of pixels in the current block. The pixel in the neighboring block is in same line as the run of pixels in the current block and inline with the run of pixels relative to a scan order of the current block.

The pixel in the neighboring block is inline with the run of pixels relative to a scan order of the current block means that if the scan order is horizontal, the pixel in the neighboring block is horizontal to the run of pixels and if the scan order is vertical, the pixel in the neighboring block is vertical to the run of pixels. For extended index copy run, based on the scan order of the current block being horizontal, the neighboring block is a block left of the current block and the pixel in the neighboring block is a pixel in a last column of the neighboring block that borders the current block. Based on the scan order of the current block being vertical, the neighboring block is a block above the current block and the pixel in the neighboring block is a pixel in a last row of the neighboring block that borders the current block.

Video decoder 30 may copy the pixel value of the pixel from the neighboring block as predictor pixel values or final reconstructed pixel values for pixels in the run of pixels in the current block based on extended index copy run being enabled for the run of pixels in the line in the current block in palette mode coding of the current block. Video decoder 30 may reconstruct the current block at least in part based on the predictor pixel values (e.g., by adding the predictor pixel values to signaled residual pixel values) or the final reconstructed pixel values for pixels in the run of pixel in the line in the current block.

In some examples, video encoder 20 and video decoder 30 may be configured to apply extended copy above run or extended index copy run only if the run starts at the first pixel in the block. In other words, the above techniques may only be enabled if the run starts at the first pixel in the block. Another restriction may be imposed that when the above techniques are used, the run length may only be a multiple of integer lines. The number of lines the extended copy spans may be signaled into the bitstream.

The restriction in applying extended index copy run means that only if extended index copy run is applied to top-left pixel of the current block can extended index copy run be applied to any of the lines in the current block. For instance, for a horizontal scan of the current block, only if pixels in the first row (e.g., top row) of the current block have the same pixel value as a first pixel (e.g., top pixel) in the last column of the left neighboring block can any of the other rows in the current block utilize extended index copy run. For a vertical scan of the current block, only if pixels in the first column (e.g., leftmost column) of the current block have the same pixel value as a first pixel (e.g., leftmost pixel) in the last row of the above neighboring block can any of the other columns in the current block utilize extended index copy run.

Therefore, for lines in the current block, video decoder 30 may receive information indicating the extended index copy run for palette mode coding is enabled for a particular row or column only if extended index copy run for palette mode coding is enabled for a top-left pixel of the current block. Accordingly, video decoder 30 may determine that extended index copy run for palette mode coding is not enabled for any row or column of the current block based on extended index copy run for palette mode coding not being enabled for a first row or column in the current block. Similarly, video encoder 20 may be restricted from enabling extended index copy run for palette mode coding for any row or column of the current block based on extended index copy run for palette mode coding not being enabled for a first row or column in the current block.

A restriction that the run length may only be a multiple of integer lines means that for any row or column for which extended index copy run is enabled, video decoder 30 copies the pixel value from a pixel in a neighboring block for all pixels in that row or column (e.g., the run of pixels is the entire row or column). For example, video encoder 20 may signal information to video decoder 30 indicating that the run length is four. Assuming a horizontal scan, in this example, video decoder 30 may copy the pixel value for the top pixel in the last column of the left neighboring block as the pixel values for pixels in the entire first row of the current block, copy the pixel value for the second to the top pixel in the last column of the left neighboring block as the pixel values for pixels in the entire second row of the current block, and so forth for the first four rows.

Under the restriction that the run length be a multiple of integer lines, video decoder 30 may not stop copying of pixel values midway through a row or column, and video encoder 20 may not signal information indicating that video decoder 30 is to stop copying pixel values midway through a row or column. For example, video encoder 20 may not signal information indicating that the run length is 3.5, which would mean that video decoder 30 stops copying of pixel values in the fourth row halfway through the row. The run length may be restricted to integer values.

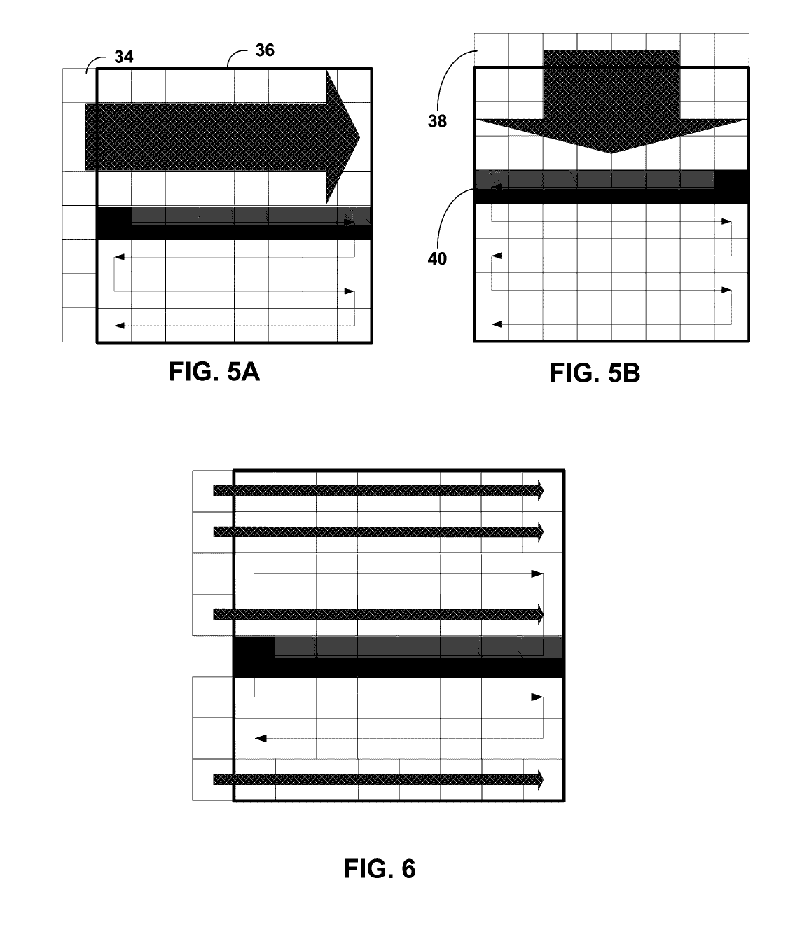

Examples of the above example restrictions are provided in FIGS. 5A and 5B. FIGS. 5A and 5B are an example of the extended copies. For instance, FIG. 5A is a conceptual diagram illustrating an example of an extended index copy, consistent with techniques of this disclosure. FIG. 5B is a conceptual diagram illustrating an example of an extended copy above, consistent with techniques of this disclosure.

FIG. 5A illustrates current block 36 with the darker border and column 34. Column 34 is the last column (e.g., column #-1) of the left neighboring block to current block 36. In the example illustrated in FIG. 5A, the scan order for block 36 is a horizontal scan, and particularly a horizontal raster scan, illustrated by the horizontal arrows in block 36.

In the illustrated example, the pixel values for each of the first four rows is the same as the pixel value of a pixel in column 34 that is in the same line. In this example, video encoder 20 may signal information indicating that extended index copy run is enabled (e.g., via palette_run_type_extension flag followed by another flag indicating extended index copy run or via code words). Video encoder 20 may also signal information indicating the run length (e.g., integer number of rows for which extended index copy run is enabled), which in the example of FIG. 5A is four. In the event that the restriction that extended index copy run can be enabled for rows or columns of block 36 only if the extended index copy run is enabled for first pixel of block 36 is applicable, the example illustrated in FIG. 5A is compliant with that restriction.

Video decoder 30 may receive information indicating that extended index copy run is enabled for a run of pixels in a line in current block 36 in palette mode coding of current block 36. Video decoder 30 may also receive information indicating that the run length is four. In this example, if the restriction that extended index copy run is only enabled for integer lines is applicable, then the example illustrated in FIG. 5A is compliant with that restriction because video decoder 30 may copy pixel values for the entire row.

As described above, in the extended index copy run, video decoder 30 may copy a pixel value of a pixel in a neighboring block for pixels in the run of pixels in the current block, where the pixel in the neighboring block is in same line as the run of pixels in the current block and inline with the run of pixels relative to a scan order of the current block. For example, video decoder 30 may copy the pixel value of the top pixel in column 34 for pixels in the run of pixels in current block 36 (e.g., the run of pixels in the current block is the first row in the current block). Video decoder 30 may copy the pixel value of the second to top pixel in column 34 for pixels in the run of pixels in current block 36 (e.g., the run of pixel in the current block is the second row in the current block), and so forth for the first four rows. In this example, the pixel whose pixel value video decoder 30 copies is in same line as the line of the run of pixels (e.g., same row) and inline relative to the horizontal scan. For instance, if the scan is horizontal scan, then the pixel whose pixel values are copied is horizontal relative to pixels in the run of pixels.

Video decoder 30 may reconstruct the current block at least in part based on the predictor pixel values or the final reconstructed pixel values for pixels in the run of pixels in the line in the current block. For instance, if video decoder 30 copies the pixel value of a pixel in column 34 as the final reconstructed pixel values for pixels in the same row of block 36, then video decoder 30 may reconstruct one row of the current block in this manner. In this example, as the run length is four, video decoder 30 may repeat these steps for the first four rows to reconstruct at least the first four rows of the current block. If video decoder 30 copies the pixel value of a pixel in column 34 as predictor pixel values for pixels in the same row of block 36, then video decoder 30 also receives residual pixel values. Video decoder 30 adds the predictor pixel values and the residual pixel values to determine the final reconstructed pixel values.

In the example illustrated in FIG. 5A, video decoder 30 receives information indicating that the extended index copy run for palette mode coding is enabled for runs of pixels in a plurality of lines in current block 36 (e.g., four rows). In such examples, video decoder 30 copies pixel values of respective pixels in the neighboring block for pixels in each of the runs of pixels in the plurality of lines in current block 36 (e.g., top pixel in column 34 for the run of pixels in the first row in current block 36, second from top pixel in column 34 for the run of pixels in the second row in current block 36, and so forth). Video decoder 30 may receive information indicating an integer number of lines in the current block for which extended index copy run for palette mode coding is enabled (e.g., four in this example).

FIG. 5B is similar to FIG. 5A except FIG. 5B illustrates in extended copy above run. FIG. 5B illustrates current block 40 with the darker border and row 38. Row 38 is the last row (e.g., row #-1) of the above neighboring block to current block 40. In the example illustrated in FIG. 5B, the scan order for block 40 is a horizontal scan, and particularly a horizontal raster scan, illustrated by the horizontal arrows in block 40.

In the illustrated example, the pixel values for each of the first three rows is the same as the pixel value of a pixel in row 38 that is in the same line. In this example, video encoder 20 may signal information indicating that extended copy above run is enabled (e.g., via palette_run_type_extension flag followed by another flag indicating extended copy above run or via code words). Video encoder 20 may also signal information indicating the run length (e.g., integer number of rows for which extended index copy run is enabled), which in the example of FIG. 5B is three. In the event that the restriction that extended copy above run can be enabled for rows or columns of block 40 only if the extended index copy run is enabled for first pixel of block 40 is applicable, the example illustrated in FIG. 5B is compliant with that restriction.

Video decoder 30 may receive information indicating that extended copy above run is enabled for a run of pixels in a line in current block 40 in palette mode coding of current block 40. Video decoder 30 may also receive information indicating that the run length is three. In this example, if the restriction that extended index copy run is only enabled for integer lines is applicable, then the example illustrated in FIG. 5B is compliant with that restriction because video decoder 30 may copy pixel values for the entire row.

As described above, in the extended copy above run, video decoder 30 may copy a pixel value of a pixel in a neighboring block for pixels in the run of pixels in the current block, where the pixel in the neighboring block is in same line as the run of pixels in the current block and orthogonal with the run of pixels relative to a scan order of the current block. For example, video decoder 30 may copy the pixel value of the leftmost pixel in row 38 for pixels in the run of pixels in current block 40 (e.g., the run of pixels in the current block is the first three rows of the first column in the current block). Video decoder 30 may copy the pixel value of the second to leftmost pixel in row 38 for pixels in the run of pixels in current block 40 (e.g., the run of pixel in the current block is the first three rows of the second column in the current block), and so forth for all columns. In this example, the pixel whose pixel value video decoder 30 copies is in same line as the line of the run of pixels (e.g., same column) and orthogonal relative to the horizontal scan. For instance, if the scan is horizontal scan, then the pixel whose pixel values are copied is orthogonal relative to pixels in the run of pixels.

Video decoder 30 may reconstruct the current block at least in part based on the predictor pixel values or the final reconstructed pixel values for pixels in the run of pixels in the line in the current block. For instance, if video decoder 30 copies the pixel value of a pixel in row 38 as the final reconstructed pixel values for pixels in the same column of block 40, then video decoder 30 may reconstruct three rows of the first column of the current block in this manner. In this example, as the run length is three, video decoder 30 may repeat these steps for the first three rows across all columns to reconstruct at least the first three rows of the current block. If video decoder 30 copies the pixel value of a pixel in column 38 as predictor pixel values for pixels in the same row of block 40, then video decoder 30 also receives residual pixel values. Video decoder 30 adds the predictor pixel values and the residual pixel values to determine the final reconstructed pixel values.

Accordingly, in one example, to code information, the video coder may code information indicating whether at least one of the extended copy above run or the extended index copy run is enabled for the current run of samples in the current block only when the current run starts at a first pixel in the current block. In this example, to copy pixels, the video coder may be configured to copy pixels from the neighboring block as predictor or final reconstructed pixel values of the current line in the current block in response to at least one of the extended copy above run or the extended index copy run being enabled for the current run of samples in the current block and the current run starting at the first pixel in the current block.

Also, in one example, to code information, the video coder may code information indicating whether at least one of the extended copy above run or the extended index copy run is enabled for the current run of samples in the current block only when a run length of the current run is a multiple of integer lines in the current block. In this example, to copy pixels, the video coder may be configured to copy pixels from the neighboring block as predictor or final reconstructed pixel values of the current line in the current block in response to at least one of the extended copy above run or the extended index copy run being enabled for the current run of samples in the current block and the run length of the current run being the multiple of integer lines.

In some examples, video encoder 20 may signal a flag for each row or column, whether extended index copy run is enabled for that row or column. If extended index copy run is enabled for a particular row or column, video decoder 30 may copy the pixel value of a respective pixel in a neighboring block that is in the same lien as the row or column for the entire row or column (e.g., entire row if horizontal scan, entire column if vertical scan).

The lines which are not using extended index copies may be coded together using regular copy above or regular index copy, as illustrated in FIG. 6. For instance, FIG. 6 is a conceptual diagram illustrating an example of an extended index copies with individual line flag, consistent with techniques of this disclosure. Pixels in non-extended index copy lines may use their above neighbor in copy above mode, or use its nearest above pixel which is not in extended index copy lines in copy above mode.

Accordingly, in some examples, based on the extended index copy run being enabled, the video coder may code a syntax element for each line that indicates whether that line uses extended index copy. Also, based on the syntax element for a line indicating that extended index copy is not used for the that line, the video coder may code that line using regular copy above or regular index copy.

For instance, as illustrated in FIG. 6, the scan is horizontal. In this example, for the first two rows, video decoder 30 may copy pixel values from respective first two pixels of the last column in the left neighboring block because these pixels are inline with the run of pixels in the first two rows. Then, for the third row, video decoder 30 may perform regular index copy. For the fourth row, video decoder 30 may copy pixel value of the pixel in the last column in the left neighboring block as the pixel value of the run of pixels in the fourth row. Then, for the fifth to seventh row, video decoder 30 may perform regular index copy and then for the eighth row, video decoder 30 may copy pixel value of the last pixel in the last column in the left neighboring block as the pixel value of the run of pixels in the eighth row.

As described above, for the fifth row, video decoder 30 may perform regular index copy. For the first pixel in the fifth row, there is no left pixel from which to copy its palette index. In regular index copy, in such a scenario, video decoder 30 copies the palette index of the last pixel in the immediately preceding row (e.g., last pixel in the fourth row). However, in the example illustrated in FIG. 6, the fourth row was palette mode coded in the extended index copy run. In some examples, to perform regular palette index copy, video decoder 30 may refer to a previous pixel in a row or column that was not part of the extended index copy run. For instance, in FIG. 6, video decoder 30 may copy the palette index of the last pixel in the third row as the palette index for the first pixel in the fifth row.

In the example illustrated in FIG. 6, video decoder 30 may receive information indicating that the extended index copy run for palette mode coding is enabled for runs of pixels of a plurality of lines in the current block, and may copy pixel values of respective pixel in the neighboring block for pixels in each of the runs of pixels in the plurality of lines in the current block. For instance, video decoder 30 may receive a flag for each of the plurality of lines in the current block indicating whether the extended index copy run for palette mode coding is enabled for each of the plurality of lines in the current block. For the lines in the current block for which extended index copy run is enabled, video decoder 30 may copy the pixel values of respective pixels in the neighboring block that are in the same line as the respective runs of pixels and inline with the run of pixels relative to the scan order (e.g., if horizontal scan, then pixel in neighboring block is horizontally located to the run of pixels, and if vertical scan, then pixel in neighboring block is vertically located to the run of pixels).

In the examples in FIGS. 5A, 5B, and 6, there may be a first set of plurality of lines and a second set of plurality of lines in each of the blocks. The extended index copy run for palette mode coding is enabled for the first set of the plurality of lines, and the extended index copy run for palette mode coding is not enabled for the second set of plurality of lines. For example, in FIG. 5A, the first set of plurality of lines includes the first four rows, and in FIG. 6, the first set of plurality of lines includes the first, second, fourth, and eighth rows. In FIG. 5A, the second set of plurality of lines includes the fifth through eighth rows, and in FIG. 6, the second set of plurality of lines includes the third, fifth, sixth, and seventh rows.

Video decoder 30 may determine predictor pixel value or final reconstructed pixel values for pixels in the second set of the plurality of lines based on regular copy above or regular index copy. For example, video decoder 30 may copy the palette index from a previous pixel in the same block as the palette index for a current pixel, determine the pixel value in the palette based on the palette index as the predictor pixel value or the final reconstructed pixel value. For the regular copy above or regular index copy, video decoder 30 may use the palette indices for pixels that are not in the first set of the plurality of lines. For instance, in FIG. 6, for the first pixel in the fifth row, video decoder 30 may copy the palette index of the last pixel in the third row since extended index copy run is enabled for pixels in the fourth row.

A restriction on the extended index copy lines may be imposed which may require that one N consecutive lines from the first line may be in extended index copy mode. Additionally or alternatively, the M consecutive lines starting from the last line in the block may be in extended index copy mode.

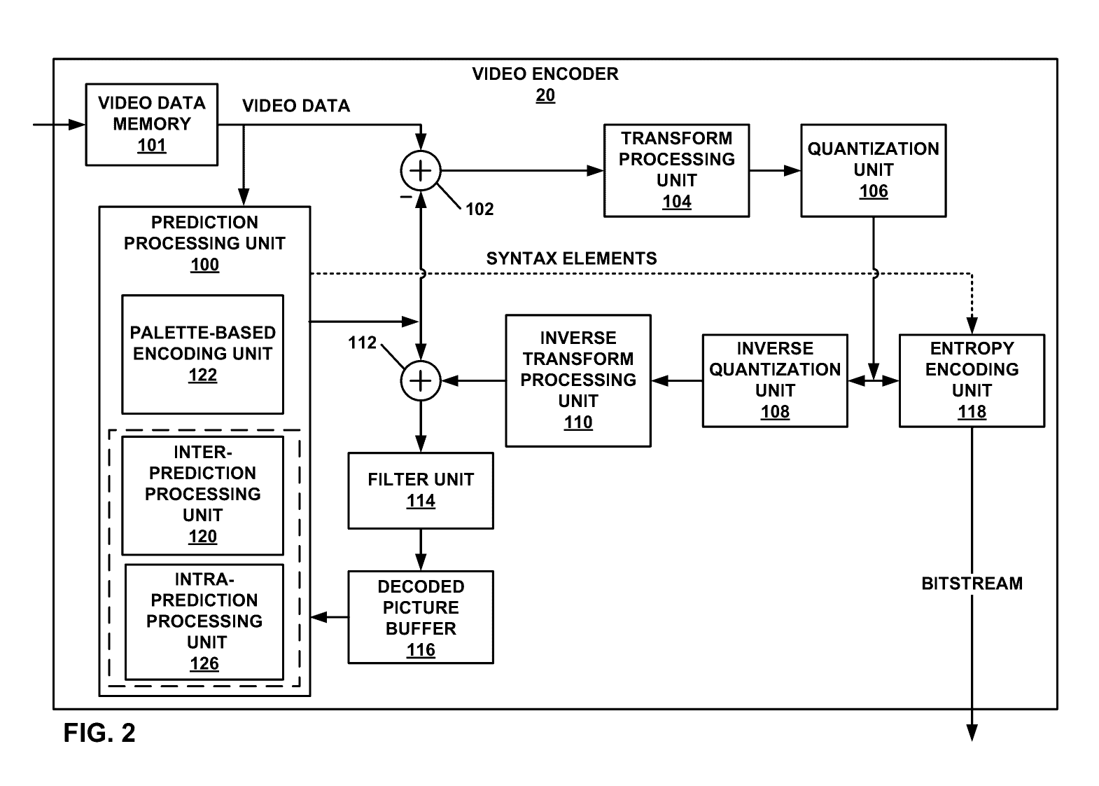

FIG. 2 is a block diagram illustrating an example video encoder 20 that may implement the techniques of this disclosure. FIG. 2 is provided for purposes of explanation and should not be considered limiting of the techniques as broadly exemplified and described in this disclosure. For purposes of explanation, this disclosure describes video encoder 20 in the context of HEVC coding. However, the techniques of this disclosure may be applicable to other coding standards or methods.

Video encoder 20 represents an example of a device that may be configured to perform techniques for palette-based video coding in accordance with various examples described in this disclosure. For example, video encoder 20 may be configured to selectively code various blocks of video data, such as CUs or PUs in HEVC coding, using either palette-based coding or non-palette-based coding. Non-palette-based coding modes may refer to various inter-predictive temporal coding modes or intra-predictive spatial coding modes, such as the various coding modes specified by the HEVC standard. Video encoder 20, in one example, may be configured to generate a palette having entries indicating pixel values, select pixel values in a palette to represent pixels values of at least some pixel locations in a block of video data, and signal information associating at least some of the pixel locations in the block of video data with entries in the palette corresponding, respectively, to the selected pixel values in the palette. The signaled information may be used by video decoder 30 to decode video data.

In the example of FIG. 2, video encoder 20 includes a prediction processing unit 100, video data memory 101, a residual generation unit 102, a transform processing unit 104, a quantization unit 106, an inverse quantization unit 108, an inverse transform processing unit 110, a reconstruction unit 112, a filter unit 114, a decoded picture buffer 116, and an entropy encoding unit 118. Prediction processing unit 100 includes an inter-prediction processing unit 120 and an intra-prediction processing unit 126. Inter-prediction processing unit 120 includes a motion estimation unit and a motion compensation unit (not shown). Video encoder 20 also includes a palette-based encoding unit 122 configured to perform various aspects of the palette-based coding techniques described in this disclosure. In other examples, video encoder 20 may include more, fewer, or different functional components.

Video data memory 101 may store video data to be encoded by the components of video encoder 20. The video data stored in video data memory 101 may be obtained, for example, from video source 18. Decoded picture buffer 116 may be a reference picture memory that stores reference video data for use in encoding video data by video encoder 20, e.g., in intra- or inter-coding modes. Video data memory 101 and decoded picture buffer 116 may be formed by any of a variety of memory devices, such as dynamic random access memory (DRAM), including synchronous DRAM (SDRAM), magnetoresistive RAM (MRAM), resistive RAM (RRAM), or other types of memory devices. Video data memory 101 and decoded picture buffer 116 may be provided by the same memory device or separate memory devices. In various examples, video data memory 101 may be on-chip with other components of video encoder 20, or off-chip relative to those components.

Video encoder 20 may receive video data. Video encoder 20 may encode each CTU in a slice of a picture of the video data. Each of the CTUs may be associated with equally-sized luma coding tree blocks (CTBs) and corresponding CTBs of the picture. As part of encoding a CTU, prediction processing unit 100 may perform quad-tree partitioning to divide the CTBs of the CTU into progressively-smaller blocks. The smaller block may be coding blocks of CUs. For example, prediction processing unit 100 may partition a CTB associated with a CTU into four equally-sized sub-blocks, partition one or more of the sub-blocks into four equally-sized sub-sub-blocks, and so on.

Video encoder 20 may encode CUs of a CTU to generate encoded representations of the CUs (i.e., coded CUs). As part of encoding a CU, prediction processing unit 100 may partition the coding blocks associated with the CU among one or more PUs of the CU. Thus, each PU may be associated with a luma prediction block and corresponding chroma prediction blocks. Video encoder 20 and video decoder 30 may support PUs having various sizes. As indicated above, the size of a CU may refer to the size of the luma coding block of the CU and the size of a PU may refer to the size of a luma prediction block of the PU. Assuming that the size of a particular CU is 2N×2N, video encoder 20 and video decoder 30 may support PU sizes of 2N×2N or N×N for intra prediction, and symmetric PU sizes of 2N×2N, 2N×N, N×2N, N×N, or similar for inter prediction. Video encoder 20 and video decoder 30 may also support asymmetric partitioning for PU sizes of 2N×nU, 2N×nD, nL×2N, and nR×2N for inter prediction.

Inter-prediction processing unit 120 may generate predictive data for a PU by performing inter prediction on each PU of a CU. The predictive data for the PU may include predictive blocks of the PU and motion information for the PU. Inter-prediction unit 121 may perform different operations for a PU of a CU depending on whether the PU is in an I slice, a P slice, or a B slice. In an I slice, all PUs are intra predicted. Hence, if the PU is in an I slice, inter-prediction unit 121 does not perform inter prediction on the PU. Thus, for blocks encoded in I-mode, the predicted block is formed using spatial prediction from previously-encoded neighboring blocks within the same frame.

If a PU is in a P slice, the motion estimation unit of inter-prediction processing unit 120 may search the reference pictures in a list of reference pictures (e.g., “RefPicList0”) for a reference region for the PU. The reference region for the PU may be a region, within a reference picture, that contains sample blocks that most closely corresponds to the sample blocks of the PU. The motion estimation unit may generate a reference index that indicates a position in RefPicList0 of the reference picture containing the reference region for the PU. In addition, the motion estimation unit may generate an MV that indicates a spatial displacement between a coding block of the PU and a reference location associated with the reference region. For instance, the MV may be a two-dimensional vector that provides an offset from the coordinates in the current decoded picture to coordinates in a reference picture. The motion estimation unit may output the reference index and the MV as the motion information of the PU. The motion compensation unit of inter-prediction processing unit 120 may generate the predictive blocks of the PU based on actual or interpolated samples at the reference location indicated by the motion vector of the PU.

If a PU is in a B slice, the motion estimation unit may perform uni-prediction or bi-prediction for the PU. To perform uni-prediction for the PU, the motion estimation unit may search the reference pictures of RefPicList0 or a second reference picture list (“RefPicList1”) for a reference region for the PU. The motion estimation unit may output, as the motion information of the PU, a reference index that indicates a position in RefPicList0 or RefPicList1 of the reference picture that contains the reference region, an MV that indicates a spatial displacement between a prediction block of the PU and a reference location associated with the reference region, and one or more prediction direction indicators that indicate whether the reference picture is in RefPicList0 or RefPicList1. The motion compensation unit of inter-prediction processing unit 120 may generate the predictive blocks of the PU based at least in part on actual or interpolated samples at the reference region indicated by the motion vector of the PU.

To perform bi-directional inter prediction for a PU, the motion estimation unit may search the reference pictures in RefPicList0 for a reference region for the PU and may also search the reference pictures in RefPicList1 for another reference region for the PU. The motion estimation unit may generate reference picture indexes that indicate positions in RefPicList0 and RefPicList1 of the reference pictures that contain the reference regions. In addition, the motion estimation unit may generate MVs that indicate spatial displacements between the reference location associated with the reference regions and a sample block of the PU. The motion information of the PU may include the reference indexes and the MVs of the PU. The motion compensation unit may generate the predictive blocks of the PU based at least in part on actual or interpolated samples at the reference regions indicated by the motion vectors of the PU.

In accordance with various examples of this disclosure, video encoder 20 may be configured to perform palette-based coding. With respect to the HEVC framework, as an example, the palette-based coding techniques may be configured to be used as a coding unit (CU) mode. In other examples, the palette-based coding techniques may be configured to be used as a PU mode in the framework of HEVC. Accordingly, all of the disclosed processes described herein (throughout this disclosure) in the context of a CU mode may, additionally or alternatively, apply to PU. However, these HEVC-based examples should not be considered a restriction or limitation of the palette-based coding techniques described herein, as such techniques may be applied to work independently or as part of other existing or yet to be developed systems/standards. In these cases, the unit for palette coding can be square blocks, rectangular blocks or even regions of non-rectangular shape.

Palette-based encoding unit 122, for example, may perform palette-based encoding when a palette-based encoding mode is selected, e.g., for a CU or PU. For example, palette-based encoding unit 122 may be configured to generate a palette having entries indicating pixel values, select pixel values in a palette to represent pixels values of at least some positions of a block of video data, and signal information associating at least some of the positions of the block of video data with entries in the palette corresponding, respectively, to the selected pixel values. Although various functions are described as being performed by palette-based encoding unit 122, some or all of such functions may be performed by other processing units, or a combination of different processing units. According to aspects of this disclosure, palette-based encoding unit 122 may be configured to perform any combination of the techniques for extended copies (e.g., extended copy above run or extended index copy run) described in this disclosure.

Intra-prediction processing unit 126 may generate predictive data for a PU by performing intra prediction on the PU. The predictive data for the PU may include predictive blocks for the PU and various syntax elements. Intra-prediction processing unit 126 may perform intra prediction on PUs in I slices, P slices, and B slices.

To perform intra prediction on a PU, intra-prediction processing unit 126 may use multiple intra prediction modes to generate multiple sets of predictive data for the PU. Intra-prediction processing unit 126 may use samples from sample blocks of neighboring PUs to generate a predictive block for a PU. The neighboring PUs may be above, above and to the right, above and to the left, or to the left of the PU, assuming a left-to-right, top-to-bottom encoding order for PUs, CUs, and CTUs. Intra-prediction processing unit 126 may use various numbers of intra prediction modes, e.g., 33 directional intra prediction modes. In some examples, the number of intra prediction modes may depend on the size of the region associated with the PU.

Prediction processing unit 100 may select the predictive data for PUs of a CU from among the predictive data generated by inter-prediction processing unit 120 for the PUs or the predictive data generated by intra-prediction processing unit 126 for the PUs. In some examples, prediction processing unit 100 selects the predictive data for the PUs of the CU based on rate/distortion metrics of the sets of predictive data. The predictive blocks of the selected predictive data may be referred to herein as the selected predictive blocks.

Residual generation unit 102 may generate, based on the luma, Cb and Cr coding block of a CU and the selected predictive luma, Cb and Cr blocks of the PUs of the CU, a luma, Cb and Cr residual blocks of the CU. For instance, residual generation unit 102 may generate the residual blocks of the CU such that each sample in the residual blocks has a value equal to a difference between a sample in a coding block of the CU and a corresponding sample in a corresponding selected predictive block of a PU of the CU.

Transform processing unit 104 may perform quad-tree partitioning to partition the residual blocks associated with a CU into transform blocks associated with TUs of the CU. Thus, a TU may be associated with a luma transform block and two chroma transform blocks. The sizes and positions of the luma and chroma transform blocks of TUs of a CU may or may not be based on the sizes and positions of prediction blocks of the PUs of the CU. A quad-tree structure known as a “residual quad-tree” (RQT) may include nodes associated with each of the regions. The TUs of a CU may correspond to leaf nodes of the RQT.

Transform processing unit 104 may generate transform coefficient blocks for each TU of a CU by applying one or more transforms to the transform blocks of the TU. Transform processing unit 104 may apply various transforms to a transform block associated with a TU. For example, transform processing unit 104 may apply a discrete cosine transform (DCT), a directional transform, or a conceptually similar transform to a transform block. In some examples, transform processing unit 104 does not apply transforms to a transform block. In such examples, the transform block may be processed as a transform coefficient block.

Quantization unit 106 may quantize the transform coefficients in a coefficient block. The quantization process may reduce the bit-depth associated with some or all of the transform coefficients. For example, an n-bit transform coefficient may be rounded down to an m-bit transform coefficient during quantization, where n is greater than m. Quantization unit 106 may quantize a coefficient block associated with a TU of a CU based on a quantization parameter (QP) value associated with the CU. Video encoder 20 may adjust the degree of quantization applied to the coefficient blocks associated with a CU by adjusting the QP value associated with the CU. Quantization may introduce loss of information, thus quantized transform coefficients may have lower precision than the original ones.

Inverse quantization unit 108 and inverse transform processing unit 110 may apply inverse quantization and inverse transforms to a coefficient block, respectively, to reconstruct a residual block from the coefficient block. Reconstruction unit 112 may add the reconstructed residual block to corresponding samples from one or more predictive blocks generated by prediction processing unit 100 to produce a reconstructed transform block associated with a TU. By reconstructing transform blocks for each TU of a CU in this way, video encoder 20 may reconstruct the coding blocks of the CU.

Filter unit 114 may perform one or more deblocking operations to reduce blocking artifacts in the coding blocks associated with a CU. Decoded picture buffer 116 may store the reconstructed coding blocks after filter unit 114 performs the one or more deblocking operations on the reconstructed coding blocks. Inter-prediction processing unit 120 may use a reference picture that contains the reconstructed coding blocks to perform inter prediction on PUs of other pictures. In addition, intra-prediction processing unit 126 may use reconstructed coding blocks in decoded picture buffer 116 to perform intra prediction on other PUs in the same picture as the CU.

Entropy encoding unit 118 may receive data from other functional components of video encoder 20. For example, entropy encoding unit 118 may receive coefficient blocks from quantization unit 106 and may receive syntax elements from prediction processing unit 100. Entropy encoding unit 118 may perform one or more entropy encoding operations on the data to generate entropy-encoded data. For example, entropy encoding unit 118 may perform a context-adaptive variable length coding (CAVLC) operation, a CABAC operation, a variable-to-variable (V2V) length coding operation, a syntax-based context-adaptive binary arithmetic coding (SBAC) operation, a Probability Interval Partitioning Entropy (PIPE) coding operation, an Exponential-Golomb encoding operation, or another type of entropy encoding operation on the data. Video encoder 20 may output a bitstream that includes entropy-encoded data generated by entropy encoding unit 118. For instance, the bitstream may include data that represents a RQT for a CU.

As described above, palette-based encoding unit 122 may be configured to perform the operations in accordance with one or more example techniques described in this disclosure. Palette-based encoding unit 122 may be formed as fixed-function or programmable circuitry.

For example, palette-based encoding unit 122 may perform various types of test palette mode coding techniques on a current block to determine whether extended index copy run provides suitable video coding compression while balancing video quality. As an example, palette-based encoding unit 122 may retrieve pixel value for a pixel in a last row or column of a neighboring block from DPB 116. Palette-based encoding unit 122 may compare that pixel value with pixel values in a row or column in the current block that are in the same row or column as the pixel in the neighboring block. If the pixel values in the row or column in the current block are substantially same as pixel value in the neighboring block (e.g., exactly the same or difference is relatively minimal), palette-based encoding unit 122 may determine that extended index copy run is to be enabled for a run of pixels in the line (e.g., row or column). Palette-based encoding unit 122 may repeat such operations to determine for which rows or columns extended index copy run is enabled.

Palette-based encoding unit 122 may signal information indicating that extended index copy run is enabled for a run of pixels in a line in a current block in palette mode coding of the current block. For instance, palette-based encoding unit 122 may signal information indicating whether extended copies is enabled and then whether extended index copy run or extended copy above run is enabled. As another example, palette-based encoding unit 122 may signal code words that indicate whether regular index copy, extended index copy run, or extended copy above run is enabled. In addition, palette-based encoding unit 122 may signal information indicating the run length (e.g., number of integer rows or columns) for which the extended index copy run is enabled. In some examples, palette-based encoding unit 122 may be restricted from enabling extended index copy run or extended copy above run for any line in the current block if the extended index copy run or extended copy above run is not enabled for the first row or column in the current block.

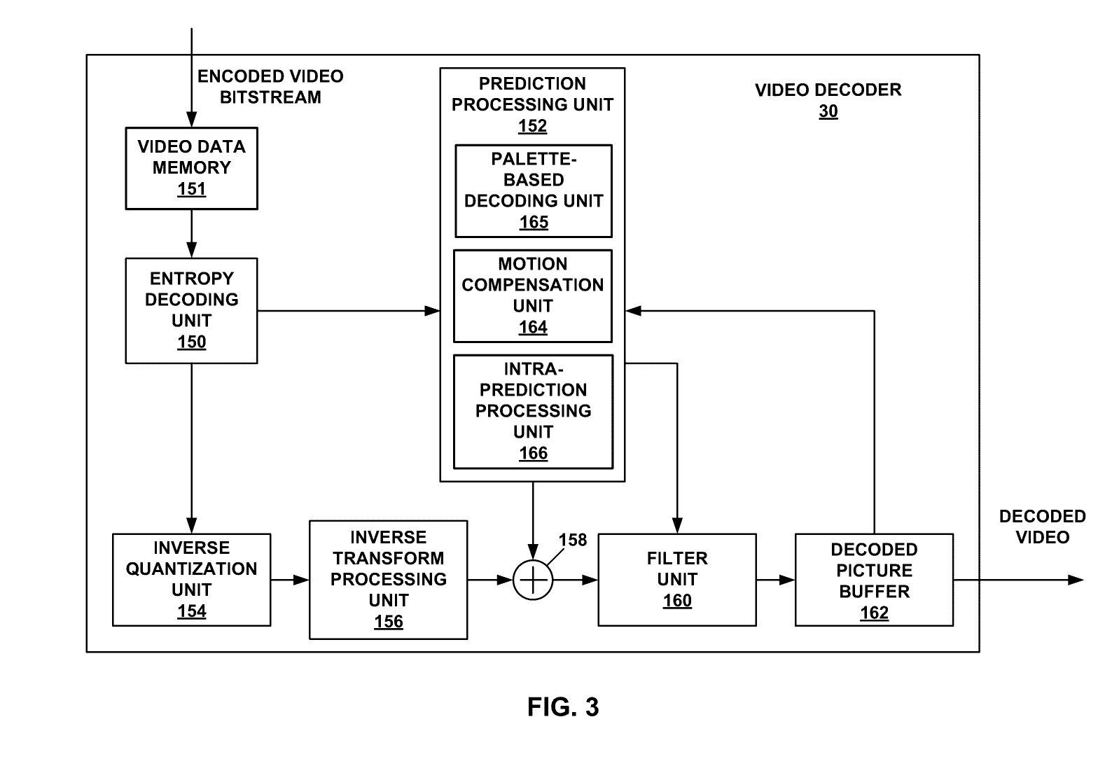

FIG. 3 is a block diagram illustrating an example video decoder 30 that is configured to implement the techniques of this disclosure. FIG. 3 is provided for purposes of explanation and is not limiting on the techniques as broadly exemplified and described in this disclosure. For purposes of explanation, this disclosure describes video decoder 30 in the context of HEVC coding. However, the techniques of this disclosure may be applicable to other coding standards or methods.

Video decoder 30 represents an example of a device that may be configured to perform techniques for palette-based video coding in accordance with various examples described in this disclosure. For example, video decoder 30 may be configured to selectively decode various blocks of video data, such as CUs or PUs in HEVC coding, using either palette-based coding or non-palette-based coding. Non-palette-based coding modes may refer to various inter-predictive temporal coding modes or intra-predictive spatial coding modes, such as the various coding modes specified by the HEVC standard. Video decoder 30, in one example, may be configured to generate a palette having entries indicating pixel values, receive information associating at least some pixel locations in a block of video data with entries in the palette, select pixel values in the palette-based on the information, and reconstruct pixel values of the block based on the selected pixel values in the palette.

In the example of FIG. 3, video decoder 30 includes an entropy decoding unit 150, video data memory 151, a prediction processing unit 152, an inverse quantization unit 154, an inverse transform processing unit 156, a reconstruction unit 158, a filter unit 160, and a decoded picture buffer 162. Prediction processing unit 152 includes a motion compensation unit 164 and an intra-prediction processing unit 166. Video decoder 30 also includes a palette-based decoding unit 165 configured to perform various aspects of the palette-based coding techniques described in this disclosure. In other examples, video decoder 30 may include more, fewer, or different functional components.

Video data memory 151 may store video data, such as an encoded video bitstream, to be decoded by the components of video decoder 30. The video data stored in video data memory 151 may be obtained, for example, from a computer-readable medium, e.g., from a local video source, such as a camera, via wired or wireless network communication of video data, or by accessing physical data storage media. Video data memory 151 may form a coded picture buffer (CPB) that stores encoded video data from an encoded video bitstream. Decoded picture buffer 162 may be a reference picture memory that stores reference video data for use in decoding video data by video decoder 30, e.g., in intra- or inter-coding modes. Video data memory 151 and decoded picture buffer 162 may be formed by any of a variety of memory devices, such as dynamic random access memory (DRAM), including synchronous DRAM (SDRAM), magnetoresistive RAM (MRAM), resistive RAM (RRAM), or other types of memory devices. Video data memory 151 and decoded picture buffer 162 may be provided by the same memory device or separate memory devices. In various examples, video data memory 151 may be on-chip with other components of video decoder 30, or off-chip relative to those components.

A coded picture buffer (CPB) may receive and store encoded video data (e.g., NAL units) of a bitstream. Entropy decoding unit 150 may receive encoded video data (e.g., NAL units) from the CPB and parse the NAL units to decode syntax elements. Entropy decoding unit 150 may entropy decode entropy-encoded syntax elements in the NAL units.

Prediction processing unit 152, inverse quantization unit 154, inverse transform processing unit 156, reconstruction unit 158, and filter unit 160 may generate decoded video data based on the syntax elements extracted from the bitstream. The NAL units of the bitstream may include coded slice NAL units. As part of decoding the bitstream, entropy decoding unit 150 may extract and entropy decode syntax elements from the coded slice NAL units. Each of the coded slices may include a slice header and slice data. The slice header may contain syntax elements pertaining to a slice. The syntax elements in the slice header may include a syntax element that identifies a PPS associated with a picture that contains the slice.

In addition to decoding syntax elements from the bitstream, video decoder 30 may perform a reconstruction operation on a non-partitioned CU. To perform the reconstruction operation on a non-partitioned CU, video decoder 30 may perform a reconstruction operation on each TU of the CU. By performing the reconstruction operation for each TU of the CU, video decoder 30 may reconstruct residual blocks of the CU.

As part of performing a reconstruction operation on a TU of a CU, inverse quantization unit 154 may inverse quantize, i.e., de-quantize, coefficient blocks associated with the TU. Inverse quantization unit 154 may use a QP value associated with the CU of the TU to determine a degree of quantization and, likewise, a degree of inverse quantization for inverse quantization unit 154 to apply. That is, the compression ratio, i.e., the ratio of the number of bits used to represent original sequence and the compressed one, may be controlled by adjusting the value of the QP used when quantizing transform coefficients. The compression ratio may also depend on the method of entropy coding employed.

After inverse quantization unit 154 inverse quantizes a coefficient block, inverse transform processing unit 156 may apply one or more inverse transforms to the coefficient block in order to generate a residual block associated with the TU. For example, inverse transform processing unit 156 may apply an inverse DCT, an inverse integer transform, an inverse Karhunen-Loeve transform (KLT), an inverse rotational transform, an inverse directional transform, or another inverse transform to the coefficient block.

If a PU is encoded using intra prediction, intra-prediction processing unit 166 may perform intra prediction to generate predictive blocks for the PU. Intra-prediction processing unit 166 may use an intra prediction mode to generate the predictive luma, Cb and Cr blocks for the PU based on the prediction blocks of spatially-neighboring PUs. Intra-prediction processing unit 166 may determine the intra prediction mode for the PU based on one or more syntax elements decoded from the bitstream.

Prediction processing unit 152 may construct a first reference picture list (RefPicList0) and a second reference picture list (RefPicList1) based on syntax elements extracted from the bitstream. Furthermore, if a PU is encoded using inter prediction, entropy decoding unit 150 may extract motion information for the PU. Motion compensation unit 164 may determine, based on the motion information of the PU, one or more reference regions for the PU. Motion compensation unit 164 may generate, based on samples blocks at the one or more reference blocks for the PU, predictive luma, Cb and Cr blocks for the PU.

Reconstruction unit 158 may use the luma, Cb and Cr transform blocks associated with TUs of a CU and the predictive luma, Cb and Cr blocks of the PUs of the CU, i.e., either intra-prediction data or inter-prediction data, as applicable, to reconstruct the luma, Cb and Cr coding blocks of the CU. For example, reconstruction unit 158 may add samples of the luma, Cb and Cr transform blocks to corresponding samples of the predictive luma, Cb and Cr blocks to reconstruct the luma, Cb and Cr coding blocks of the CU.

Filter unit 160 may perform a deblocking operation to reduce blocking artifacts associated with the luma, Cb and Cr coding blocks of the CU. Video decoder 30 may store the luma, Cb and Cr coding blocks of the CU in decoded picture buffer 162. Decoded picture buffer 162 may provide reference pictures for subsequent motion compensation, intra prediction, and presentation on a display device, such as display device 32 of FIG. 1. For instance, video decoder 30 may perform, based on the luma, Cb, and Cr blocks in decoded picture buffer 162, intra prediction or inter prediction operations on PUs of other CUs.

In accordance with various examples of this disclosure, video decoder 30 may be configured to perform palette-based coding. Palette-based decoding unit 165, for example, may perform palette-based decoding when a palette-based decoding mode is selected, e.g., for a CU or PU. For example, palette-based decoding unit 165 may be configured to generate a palette having entries indicating pixel values, receive information associating at least some pixel locations in a block of video data with entries in the palette, select pixel values in the palette-based on the information, and reconstruct pixel values of the block based on the selected pixel values in the palette. Although various functions are described as being performed by palette-based decoding unit 165, some or all of such functions may be performed by other processing units, or a combination of different processing units.

Palette-based decoding unit 165 may receive palette coding mode information, and perform the above operations when the palette coding mode information indicates that the palette coding mode applies to the block. When the palette coding mode information indicates that the palette coding mode does not apply to the block, or when other mode information indicates the use of a different mode, video decoder 30 may decode block of video data using a non-palette-based coding mode, e.g., such an HEVC inter-predictive or intra-predictive coding mode. The block of video data may be, for example, a CU or PU generated according to an HEVC coding process. According to aspects of this disclosure, palette-based decoding unit 165 may be configured to copy pixels from a neighboring block as predictor or final reconstructed pixel values of a current line in the current block in response to at least one of the extended copy above run or the extended index copy run being enabled for the current run of samples in the current block in palette-based video coding of the current block.

In the example techniques described in this disclosure, palette-based decoding unit 165 may receive information indicating that extended index copy run is enabled for a run of pixels in a line in a current block in palette mode coding of the current block, where in the extended index copy run, a pixel value of a pixel in a neighboring block stored in DPB 162 (which may be part of video data memory 151) is copied for pixels in the run of pixels in the current block, and the pixel in the neighboring block is in same line as the run of pixels in the current block and inline with the run of pixels relative to a scan order of the current block. Palette-based decoding unit 165 may copy from video data memory 151, which include DPB 162, the pixel value of the pixel from the neighboring block as predictor pixel values or final reconstructed pixel values for pixels in the run of pixels in the current block based on extended index copy run being enabled for the run of pixels in the line in the current block in palette mode coding of the current block. Video decoder 30 may reconstruct the current block at least in part based on the predictor pixel values or the final reconstructed pixel values for pixels in the run of pixels in the line in the current block.

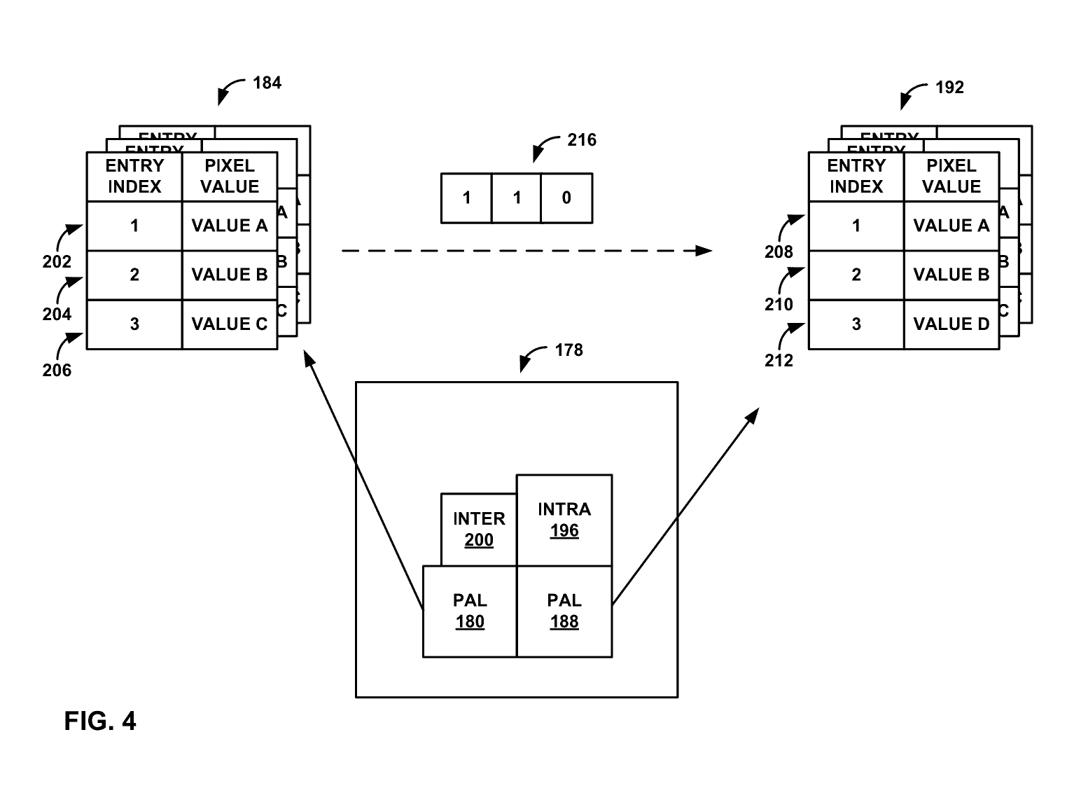

FIG. 4 is a conceptual diagram illustrating an example of determining a palette for coding video data, consistent with techniques of this disclosure. The example of FIG. 4 includes a picture 178 having a first coding unit (CU) 180 that is associated with first palettes 184 and a second CU 188 that is associated with second palettes 192. As described in greater detail below and in accordance with the techniques of this disclosure, second palettes 192 are based on first palettes 184. Picture 178 also includes block 196 coded with an intra-prediction coding mode and block 200 that is coded with an inter-prediction coding mode.

The techniques of FIG. 4 are described in the context of video encoder 20 (FIG. 1 and FIG. 2) and video decoder 30 (FIG. 1 and FIG. 3) and with respect to the HEVC video coding standard for purposes of explanation. However, it should be understood that the techniques of this disclosure are not limited in this way, and may be applied by other video coding processors and/or devices in other video coding processes and/or standards.

In general, a palette refers to a number of pixel values that are dominant and/or representative for a CU currently being coded, CU 188 in the example of FIG. 4. First palettes 184 and second palettes 192 are shown as including multiple palettes. In some examples, according to aspects of this disclosure, a video coder (such as video encoder 20 or video decoder 30) may code palettes separately for each color component of a CU. For example, video encoder 20 may encode a palette for a luma (Y) component of a CU, another palette for a chroma (U) component of the CU, and yet another palette for the chroma (V) component of the CU. In this example, entries of the Y palette may represent Y values of pixels of the CU, entries of the U palette may represent U values of pixels of the CU, and entries of the V palette may represent V values of pixels of the CU.

In other examples, video encoder 20 may encode a single palette for all color components of a CU. In this example, video encoder 20 may encode a palette having an i-th entry that is a triple value, including Yi, Ui, and Vi. In this case, the palette includes values for each of the components of the pixels. Accordingly, the representation of palettes 184 and 192 as a set of palettes having multiple individual palettes is merely one example and not intended to be limiting.

In the example of FIG. 4, first palettes 184 includes three entries 202-206 having entry index value 1, entry index value 2, and entry index value 3, respectively. Entries 202-206 relate the index values to pixel values including pixel value A, pixel value B, and pixel value C, respectively. As described herein, rather than coding the actual pixel values of first CU 180, a video coder (such as video encoder 20 or video decoder 30) may use palette-based coding to code the pixels of the block using the indices 1-3. That is, for each pixel position of first CU 180, video encoder 20 may encode an index value for the pixel, where the index value is associated with a pixel value in one or more of first palettes 184. Video decoder 30 may obtain the index values from a bitstream and reconstruct the pixel values using the index values and one or more of first palettes 184. Thus, first palettes 184 are transmitted by video encoder 20 in an encoded video data bitstream for use by video decoder 30 in palette-based decoding.

In some examples, video encoder 20 and video decoder 30 may vary, using the one or more syntax elements that indicate the maximum palette size, the maximum palette size may be based on the particular profile, level, or bit-depth of the video data being coded. In other examples, video encoder 20 and video decoder 30 may vary, using the one or more syntax elements that indicate the maximum palette size, the maximum palette size may be based on a size of the block being coded, such as CU 180.

In an example for purposes of illustration, video encoder 20 and video decoder 30 may use the data indicating a maximum palette size when constructing first palettes 184 for CU 180. For example, video encoder 20 and video decoder 30 may continue to add entries to first palettes 184 until reaching the maximum palette size indicated by the data. Video encoder 20 and video decoder 30 may then code CU 180 using the constructed first palettes 184.

In some examples, video encoder 20 and video decoder 30 may determine second palettes 192 based on first palettes 184. For example, video encoder 20 and/or video decoder 30 may locate one or more blocks from which the predictive palettes, in this example, first palettes 184, are determined. The combination of entries being used for purposes of prediction may be referred to as a predictor palette.

In the example of FIG. 4, second palettes 192 include three entries 208-212 having entry index value 1, entry index value 2, and entry index value 3, respectively. Entries 208-212 relate the index values to pixel values including pixel value A, pixel value B, and pixel value D, respectively. In this example, video encoder 20 may code one or more syntax elements indicating which entries of first palettes 184 (representing a predictor palette, although the predictor palette may include entries of a number of blocks) are included in second palettes 192.

In the example of FIG. 4, the one or more syntax elements are illustrated as a vector 216. Vector 216 has a number of associated bins (or bits), with each bin indicating whether the palette predictor associated with that bin is used to predict an entry of the current palette. For example, vector 216 indicates that the first two entries of first palettes 184 (202 and 204) are included in second palettes 192 (a value of “1” in vector 216), while the third entry of first palettes 184 is not included in second palettes 192 (a value of “0” in vector 216). In the example of FIG. 4, the vector is a Boolean vector. The vector may be referred to as a palette prediction vector.

In some examples, as noted above, video encoder 20 and video decoder 30 may determine a palette predictor (which may also be referred to as a palette predictor table or palette predictor list) when performing palette prediction. The palette predictor may include entries from palettes of one or more neighboring blocks that are used to predict one or more entries of a palette for coding a current block. Video encoder 20 and video decoder 30 may construct the list in the same manner. Video encoder 20 and video decoder 30 may code data (such as vector 216) to indicate which entries of the palette predictor are to be copied to a palette for coding a current block.

Thus, in some examples, previously decoded palette entries are stored in a list for use as a palette predictor. This list may be used to predict palette entries in the current palette mode CU. A binary prediction vector may be signaled in the bitstream to indicate which entries in the list are re-used in the current palette.

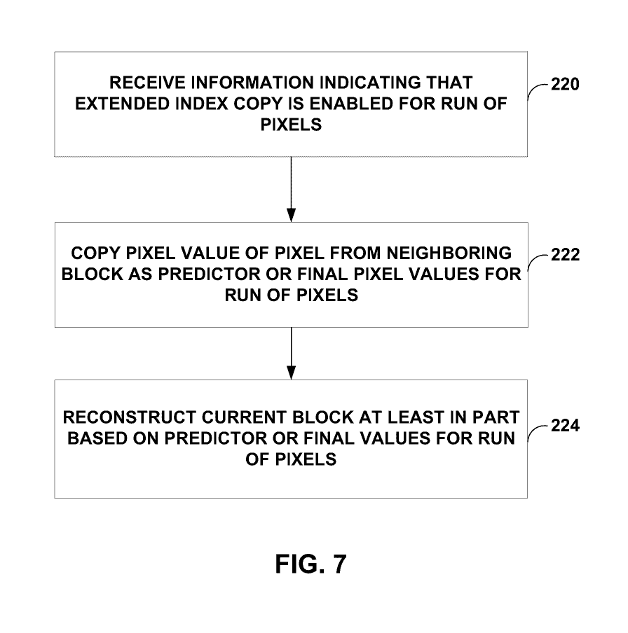

FIG. 7 is a flowchart illustrating an example method of decoding video data, consistent with techniques of this disclosure. For purposes of illustration, the example illustrated in FIG. 7 is described with respect to palette-based decoding unit 165 which may be fixed-function or programmable circuitry of video decoder 30. As palette-based decoding unit 165 is part of video decoder 30, the example described in FIG. 7 may be considered as techniques of video decoder 30 being configured to perform the example operations.

Palette-based decoding unit 165 may receive information indicating that extended index copy run is enabled for a run of pixel in a line in a current block in palette mode coding of the current block (220). For instance, video decoder 30 may receive a syntax element indicating that extended copies is enabled, followed by a syntax element indicating whether extended index copy run is enabled or extended copy above run is enabled. As another example, video decoder 30 may receive information such as code words indicating that extended index copy run is enabled for a run of pixels in a line in the current block.

In the extended index copy run, palette-based decoding unit 165 may copy from video data memory 151 a pixel value of a pixel in a neighboring block for pixels in the run of pixels in the current block as predictor pixel values or reconstructed pixel values for pixels in the run of pixels in the current block based on extended index copy run being enabled for the run of pixels in the line in the current block (222). The pixel in the neighboring block is in same line as the run of pixels in the current block and inline with the run of pixels relative to a scan order of the current block. For example, based on the scan order of the current block being horizontal scan, the neighboring block comprises a block left of the current block and the pixel in the neighboring block comprises a pixel in a last column of the neighboring block that borders the current block. Based on the scan order of the current block being vertical scan, the neighboring block comprises a block above the current block and the pixel in the neighboring block comprises a pixel in a last row of the neighboring block that borders the current block.

Palette-based decoding unit 165 may also receive information indicating that extended index copy run is enabled for runs of pixels in a plurality of lines in the current block, and may copy from video data memory 151 pixel values of respective pixels in the neighboring block for pixels in each of the runs of pixels in the plurality of lines in the current block. As one example, palette-based decoding unit 165 may receive a flag for each of the plurality of lines in the current block indicating whether the extended index copy run is enabled for each of the plurality of lines in the current block. As another example, palette-based decoding unit 165 may receive information indicating an integer number of lines in the current block for which extended index copy run for palette mode coding is enabled.

In examples where there are multiple lines for which extended index copy run is enabled, there may be a first set of plurality of lines for which extended index copy run is enabled and a second set of plurality of lines for which extended copy run for palette mode coding is not enabled. Palette-based decoding unit 165 may palette mode decode pixels in the second set of plurality of lines using regular index copy or regular copy above. For regular copy above or regular index copy, palette-based decoding unit 165 may use the palette indices for pixels that are not in the first set of the plurality of lines.

Palette-based decoding unit 165 may reconstruct the current block at least in part based on the predictor pixel values or the final reconstructed pixel values for pixels in the run of pixels in the current block (224). For instance, palette-based decoding unit 165 may repeat the above example operations for each of the rows or columns in the current block for which extended index copy run is enabled. For the rows or columns for which extended index copy run is not enabled, palette-based decoding unit 165 may perform regular index copy or regular copy above to determine the predictor pixel values or the final reconstructed pixel values. In examples where palette-based decoding unit 165 determines the predictor pixel values, palette-based decoding unit 165 may receive residual pixel values to which palette-based decoding unit 165 adds the predictor pixel values to determine the final reconstructed pixel values.

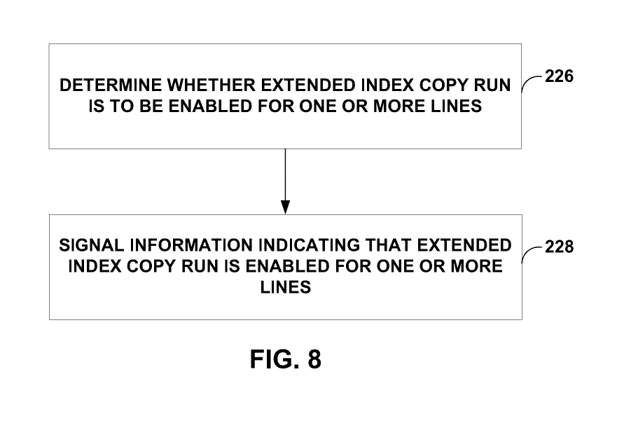

FIG. 8 is a flowchart illustrating an example method of encoding video data, consistent with techniques of this disclosure. For purposes of illustration, the example illustrated in FIG. 8 is described with respect to palette-based encoding unit 122 which may be fixed-function or programmable circuitry of video encoder 20. As palette-based encoding unit 122 is part of video encoder 20, the example described in FIG. 8 may be considered as techniques of video encoder 20 being configured to perform the example operations.

Palette-based encoding unit 122 may determine whether to enable extended index copy run for one or more lines (e.g., runs of pixels) in the current block (226). For example, palette-based encoding unit 122 may determine whether pixels in a row or column of current block are substantially similar to a pixel in a neighboring block that is in the same line as the row or column of the current block and inline relative to the scan order (e.g., if horizontal scan for the current block, then pixel in neighboring block is located horizontally to run of pixels, and if vertical scan for the current block, then pixel in neighboring block is located vertically to run of pixels).

Video encoder 20 may signal information indicating that extended index copy run is enabled for one or more lines based on the determination to enable extended index copy run for one or more lines (228). For example, palette-based encoding unit 122 may cause video encoder 20 to signal information indicating that extended copies is enabled, followed by information indicating that extended index copy run is enabled. As another example, palette-based encoding unit 122 may cause video encoder 20 to signal information as code words indicating that extended index copy run is enabled.

In some examples, palette-based encoding unit 122 may cause video encoder 20 to signal information indicating a number of lines in the current block for which extended index copy run is enabled. In some examples, palette-based encoding unit 122 may cause video encoder 20 to signal information (e.g., a flag) indicating on a line-by-line basis for a plurality of lines whether the extended index copy run is enabled for each of the plurality of lines in the current block.

For lines for which extended index copy run or extended copy above run is not enabled, palette-based encoding unit 122 may utilize regular index copy or copy above for palette mode encoding. For pixels for which palette-based encoding unit 122 is palette mode encoding utilizing regular index copy or copy above, palette-based encoding unit 122 may utilize palette indices only of pixels for which the extended index copy run or extended copy above run was not enabled.

It is to be recognized that depending on the example, certain acts or events of any of the techniques described herein can be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially. In addition, while certain aspects of this disclosure are described as being performed by a single module or unit for purposes of clarity, it should be understood that the techniques of this disclosure may be performed by a combination of units or modules associated with a video coder.

Certain aspects of this disclosure have been described with respect to the developing HEVC standard for purposes of illustration. However, the techniques described in this disclosure may be useful for other video coding processes, including other standard or proprietary video coding processes not yet developed.

The techniques described above may be performed by video encoder 20 (FIGS. 1 and 2) and/or video decoder 30 (FIGS. 1 and 3), both of which may be generally referred to as a video coder. Likewise, video coding may refer to video encoding or video decoding, as applicable.

While particular combinations of various aspects of the techniques are described above, these combinations are provided merely to illustrate examples of the techniques described in this disclosure. Accordingly, the techniques of this disclosure should not be limited to these example combinations and may encompass any conceivable combination of the various aspects of the techniques described in this disclosure.

In one or more examples, the functions described may be implemented in hardware, software, firmware, or any combination thereof. If implemented in software, the functions may be stored on or transmitted over, as one or more instructions or code, a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transient media, but are instead directed to non-transient, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

1: A method of decoding video data, the method comprising:
receiving information indicating that extended index copy run is enabled for a run of pixels in a line in a current block in palette mode coding of the current block, wherein in the extended index copy run, a pixel value of a pixel in a neighboring block is copied for pixels in the run of pixels in the current block, and wherein the pixel in the neighboring block is in same line as the run of pixels in the current block and inline with the run of pixels relative to a scan order of the current block;
copying the pixel value of the pixel from the neighboring block as predictor pixel values or final reconstructed pixel values for pixels in the run of pixels in the current block based on extended index copy run being enabled for the run of pixels in the line in the current block in palette mode coding of the current block; and
reconstructing the current block at least in part based on the predictor pixel values or the final reconstructed pixel values for pixels in the run of pixels in the line in the current block.

2: The method of claim 1, wherein, based on the scan order of the current block being horizontal scan, the neighboring block comprises a block left of the current block and the pixel in the neighboring block comprises a pixel in a last column of the neighboring block that borders the current block, and wherein, based on the scan order of the current block being vertical scan, the neighboring block comprises a block above the current block and the pixel in the neighboring block comprises a pixel in a last row of the neighboring block that borders the current block.

3: The method of claim 1, further comprising:
receiving information indicating that the extended index copy run for palette mode coding is enabled for runs of pixels in a plurality of lines in the current block; and
copying pixel values of respective pixels in the neighboring block for pixels in each of the runs of pixels in the plurality of lines in the current block.

4: The method of claim 3, wherein receiving information indicating that the extended index copy run for palette mode coding is enabled for runs of pixels in the plurality of lines in the current block comprises receiving a flag for each of the plurality of lines in the current block indicating whether the extended index copy run for palette mode coding is enabled for each of the plurality of lines in the current block.

5: The method of claim 3, wherein receiving information indicating that the extended index copy run for palette mode coding is enabled for runs of pixels in the plurality of lines in the current block comprises receiving information indicating an integer number of lines in the current block for which extended index copy run for palette mode coding is enabled.

6: The method of claim 1, wherein the current block comprises a first set of plurality of lines and a second set of plurality of lines, wherein the extended index copy run for palette mode coding is enabled for the first set of the plurality of lines, and wherein the extended index copy run for palette mode coding is not enabled for the second set of the plurality of lines.

7: The method of claim 6, further comprising:
determining predictor pixel values or final reconstructed pixel values for pixels in the second set of the plurality of lines based on regular copy above or regular index copy of palette mode coding, wherein for regular copy above or regular index copy, palette indices for pixels that are not in the first set of the plurality of lines are used for palette mode coding.

8: The method of claim 1, further comprising:
determining that extended index copy run for palette mode coding is not enabled for any row or column of the current block based on extended index copy run for palette mode coding not being enabled for a first row or column in the current block.

9: A device for decoding video data, the device comprising:
a video data memory configured to store pixel values of pixels; and
a video decoder coupled to the video data memory and comprising at least one of fixed-function or programmable circuitry, the video decoder configured to:
receive information indicating that extended index copy run is enabled for a run of pixels in a line in a current block in palette mode coding of the current block, wherein in the extended index copy run, a pixel value of a pixel in a neighboring block stored in the video data memory is copied for pixels in the run of pixels in the current block, and wherein the pixel in the neighboring block is in same line as the run of pixels in the current block and inline with the run of pixels relative to a scan order of the current block;
copy from the video data memory the pixel value of the pixel from the neighboring block as predictor pixel values or final reconstructed pixel values for pixels in the run of pixels in the current block based on extended index copy run being enabled for the run of pixels in the line in the current block in palette mode coding of the current block; and
reconstruct the current block at least in part based on the predictor pixel values or the final reconstructed pixel values for pixels in the run of pixels in the line in the current block.

10: The device of claim 9, wherein, based on the scan order of the current block being horizontal scan, the neighboring block comprises a block left of the current block and the pixel in the neighboring block comprises a pixel in a last column of the neighboring block that borders the current block, and wherein, based on the scan order of the current block being vertical scan, the neighboring block comprises a block above the current block and the pixel in the neighboring block comprises a pixel in a last row of the neighboring block that borders the current block.

11: The device of claim 9, wherein the video decoder is configured to:
receive information indicating that the extended index copy run for palette mode coding is enabled for runs of pixels in a plurality of lines in the current block; and
copy from the video data memory pixel values of respective pixels in the neighboring block for pixels in each of the runs of pixels in the plurality of lines in the current block.

12: The device of claim 11, wherein to receive information indicating that the extended index copy run for palette mode coding is enabled for runs of pixels in the plurality of lines in the current block, the video decoder is configured to receive a flag for each of the plurality of lines in the current block indicating whether the extended index copy run for palette mode coding is enabled for each of the plurality of lines in the current block.

13: The device of claim 11, wherein to receive information indicating that the extended index copy run for palette mode coding is enabled for runs of pixels in the plurality of lines in the current block, the video decoder is configured to receive information indicating an integer number of lines in the current block for which extended index copy run for palette mode coding is enabled.

14: The device of claim 9, wherein the current block comprises a first set of plurality of lines and a second set of plurality of lines, wherein the extended index copy run for palette mode coding is enabled for the first set of the plurality of lines, and wherein the extended index copy run for palette mode coding is not enabled for the second set of the plurality of lines.

15: The device of claim 14, wherein the video decoder is configured to:
determine predictor pixel values or final reconstructed pixel values for pixels in the second set of the plurality of lines based on regular copy above or regular index copy of palette mode coding, wherein for regular copy above or regular index copy, palette indices for pixels that are not in the first set of the plurality of lines are used for palette mode coding.

16: The device of claim 9, wherein the video decoder is configured to determine that extended index copy run for palette mode coding is not enabled for any row or column of the current block based on extended index copy run for palette mode coding not being enabled for a first row or column in the current block.

17: The device of 9, wherein the device comprises one of:
an integrated circuit;
a microprocessor; or
a wireless communication device.

18: A computer-readable storage medium storing instructions that, when executed, cause one or more processors of a device for video decoding to:
receive information indicating that extended index copy run is enabled for a run of pixels in a line in a current block in palette mode coding of the current block, wherein in the extended index copy run, a pixel value of a pixel in a neighboring block is copied for pixels in the run of pixels in the current block, and wherein the pixel in the neighboring block is in same line as the run of pixels in the current block and inline with the run of pixels relative to a scan order of the current block;
copy the pixel value of the pixel from the neighboring block as predictor pixel values or final reconstructed pixel values for pixels in the run of pixels in the current block based on extended index copy run being enabled for the run of pixels in the line in the current block in palette mode coding of the current block; and
reconstruct the current block at least in part based on the predictor pixel values or the final reconstructed pixel values for pixels in the run of pixels in the line in the current block.

19: The computer-readable storage medium of claim 18, wherein, based on the scan order of the current block being horizontal scan, the neighboring block comprises a block left of the current block and the pixel in the neighboring block comprises a pixel in a last column of the neighboring block that borders the current block, and wherein, based on the scan order of the current block being vertical scan, the neighboring block comprises a block above the current block and the pixel in the neighboring block comprises a pixel in a last row of the neighboring block that borders the current block.

20: The computer-readable storage medium of claim 19, further comprising instructions that cause the one or more processors to:
receive information indicating that the extended index copy run for palette mode coding is enabled for runs of pixels in a plurality of lines in the current block; and
copy pixel values of respective pixels in the neighboring block for pixels in each of the runs of pixels in the plurality of lines in the current block.
